(19) United States
(12) Patent Application Publication
(10) Pub. No.: US 2024/0071378 A1
(43) Pub. Date: Feb. 29, 2024

(54) AUTHORING CONTEXT AWARE POLICIES THROUGH NATURAL LANGUAGE AND DEMONSTRATIONS

(71) Applicant: Meta Platforms Technologies, LLC, Menlo Park, CA (US)

(72) Inventors: Tanya Renee JONKER, Seattle, WA (US); Ting ZHANG, Santa Clara, CA (US); Frances Cin-Yee LAI, York (CA); Anna Camilla MARTINEZ, Seattle, WA (US); Ruta Parimal DESAI, Mountlake Terrace, WA (US); Yan XU, Kirkland, WA (US); Kashyap TODI, Seattle, WA (US); Tianyi YANG, Sunnyvale, CA (US); Felix IZARRA, Redmond, CA (US)

(73) Assignee: Meta Platforms Technologies, LLC, Menlo Park, CA (US)

(21) Appl. No.: 18/458,383

(22) Filed: Aug. 30, 2023

Related U.S. Application Data
(60) Provisional application No. 63/373,940, filed on Aug. 30, 2022.

(51) Int. Cl. G10L 15/19; G06N 5/022; G06V 10/40; G06V 20/20; G10L 15/02; G10L 15/04; G10L 15/22

(52) U.S. Cl. CPC G10L 15/19; G06N 5/022; G06V 10/40; G06V 20/20; G10L 15/02; G10L 15/04; G10L 15/22

(57) ABSTRACT

The present disclosure relates to defining and modifying behavior in an extended reality environment. The systems and methods include capturing, using the one or more audio sensors, a natural language explanation of a rule or policy from the user, extracting features from the natural language explanation of the rule or policy, wherein the features include one or more conditions, one or more actions, and connections between the one or more events, conditions, and actions, predicting a control structure comprised of one or more conditional statements based on the extracted features and model parameters learned from historical rules or policies, and generating the rule or policy based on the control structure, wherein the rule or policy comprises the one or more conditional statements for executing the one or more actions based on evaluation of the one or more conditions.

### CROSS-REFERENCE TO RELATED APPLICATIONS

The present application is a non-provisional application of and claims the benefit of and priority to under 35 U.S.C. § 119(e) of U.S. Provisional Application No. 63/373,940 having a filing date of Aug. 30, 2022, the entire contents of which is incorporated herein by reference for all purposes.

### FIELD

The present disclosure relates generally to defining and modifying behavior in an extended reality environment, and more particularly, to techniques for defining and modifying behavior in an extended reality environment based on natural language processing and/or user demonstrations.

### BACKGROUND

A virtual assistant is an artificial intelligence (AI) enabled software agent that can perform tasks or services including: answer questions, provide information, play media, and provide an intuitive interface for connected devices (e.g., smart home devices) for an individual based on voice or text utterances (e.g., commands or questions). Conventional virtual assistants process the words a user speaks or types and converts them into digital data that the software can analyze. The software uses a speech and/or text recognition-algorithm to find the most likely answer, solution to a problem, information, or command for a given task. As the number of utterances increase, the software learns over time what users want when they supply various utterances. This helps improve the reliability and speed of responses and services. In addition to their self-learning ability, their customizable features and scalability have led virtual assistants to gain popularity across various domain spaces including website chat, computing devices (e.g., smart phones and vehicles), and standalone passive listening devices (e.g., smart speakers).

Even though virtual assistants have proven to be a powerful tool, these domain spaces have also proven to be an inappropriate venue for such a tool. The virtual assistant will continue to be an integral part in these domain spaces but will always likely be viewed as a complementary feature or limited use case, but not a crucial must have feature. Recently, developers have been looking for a better suited domain space for deploying virtual assistants. That domain space is extended reality. Extended reality is a form of reality that has been adjusted in some manner before presentation to a user and generally includes virtual reality (VR), augmented reality (AR), mixed reality (MR), hybrid reality, some combination thereof, and/or derivatives thereof.

Extended reality content may include generated virtual content or generated virtual content that is combined with physical content (e.g., physical or real-world objects). The extended reality content may include digital images, animations, video, audio, haptic feedback, and/or some combination thereof, and any of which may be presented in a single channel or in multiple channels (e.g., stereo video that produces a three-dimensional effect to the viewer). Extended reality may be associated with applications, products, accessories, services, and the like that can be used to create extended reality content and/or used in (e.g., perform activities in) an extended reality. An extended reality system that provides such content may be implemented on various platforms, including a head-mounted display (HMD) connected to a host computer system, a standalone HMD, a mobile device or computing system, and/or any other hardware platform capable of providing extended reality content to one or more viewers.

However, extended reality headsets and devices are limited in the way users interact with applications. Some provide hand controllers, but controllers betray the point of freeing the user's hands and limit the use of extended reality headsets. Others have developed sophisticated hand gestures for interacting with the components of extended reality applications. Hand gestures are a good medium, but they have their limits. For example, given the limited field of view that extended reality headsets have, hand gestures require users to keep their arms extended so that they enter the active area of the headset's sensors. This can cause fatigue and again limit the use of the headset. This is why virtual assistants have become important as a new interface for extended reality devices such as headsets. Virtual assistants can easily blend in with all the other features that the extended reality devices provide to their users. Virtual assistants can help users accomplish tasks with their extended reality devices that previously required controller input or hand gestures on or in view of the extended reality devices. Users can use virtual assistants to open and close applications, activate features, or interact with virtual objects. When combined with other technologies such as eye tracking, virtual assistants can become even more useful. For instance, users can query for information about the object they are staring at, or ask the virtual assistant to revolve, move, or manipulate a virtual object without using gestures.

### SUMMARY

Embodiments described herein pertain to techniques for defining and modifying context aware policies based on natural language processing and/or user demonstrations.

In various embodiments, a head-mounted device is provided. The head-mounted device includes a display-to-display content to a user, one or more audio sensors to capture audio, and one or more cameras to capture images of a visual field of the user wearing the head-mounted device, one or more processors, and one or more memories accessible to the one or more processors, the one or more memories storing a plurality of instructions executable by the one or more processors. The plurality of instructions including instructions that when executed by the one or more processors cause the one or more processors to perform operations. The operations comprise capturing, using the one or more audio sensors, a natural language explanation of a rule or policy from the user and extracting features from the natural language explanation of the rule or policy, wherein the features include: (i) one or more conditions, (ii) one or more actions, and (iii) connections between the one or more events, conditions, and actions. The processing also includes predicting a control structure comprised of one or more conditional statements based on the extracted features and model parameters learned from historical rules or policies and generating the rule or policy based on the control structure, wherein the rule or policy comprises the one or more conditional statements for executing the one or more actions based on evaluation of the one or more conditions.

In some embodiments, the extracting the features includes segmenting the natural language explanation into sentences or utterances, tokenizing the sentences or utterances to generate a list of words for each sentence or utterance, labeling parts of speech within the sentences and utterances based on the list of words for each sentence or utterance, detecting named entities within the sentences and utterances based on the labeled parts of speech and the list of words for each sentence or utterance, extracting, using pattern matching, various elements of the sentences or utterances based on the named entities, the labeled parts of speech, and the list of words for each sentence or utterance, wherein the various elements comprise the one or more events, conditions, and actions, extracting, using pattern matching, relationships between the various elements, wherein the relationships comprise the connections between the one or more events, conditions, and actions, and converting: (i) the one or more events, conditions, and actions and (ii) the connections between the one or more events, conditions, and actions, into a predefined output template that maintains the relationships between the one or more events, conditions, and actions based on the connections between the one or more events, conditions, and actions.

In some embodiments, the operations further include, prior to the capturing, determining a current state of the user, a complexity level of the rule or policy, a similarity score between the rule or policy and the historical rules or policies, or a combination thereof, determining a mode for the rule or policy based on the current state, the complexity level, the similarity score, or a combination thereof, wherein the mode defines a level of detail required for learning the rule or policy, and notifying the user of the level of detail required for learning the rule or policy based on the determined mode, wherein a first mode requires a natural language explanation and a second mode requires a natural language explanation and a demonstration.

In some embodiments, the operations further include capturing, using the one or more cameras, the demonstration of the rule or policy from the user, wherein the demonstration includes a series of images or frames visualizing context for the natural language explanation, extracting contextual features from the demonstration of the rule or policy, wherein the contextual features include: (i) context associated with the one or more events, conditions, and actions, and (ii) context associated with the connections between the one or more events, conditions, and actions, wherein the control structure is predicted based on the extracted features, the extracted contextual features, and the model parameters learned from the historical rule or policy information.

In some embodiments, the operations further include determining a confidence score for predicting the control structure, comparing the confidence score to a mode threshold, in response to the confidence score being below the mode threshold based on the comparing, determining additional information is required for the rule or policy and notifying the user that the additional information is required, and in response to the confidence score being at or above the mode threshold based on the comparing, determining the control structure is acceptable.

In some embodiments, the operations further include capturing, using the one or more audio sensors, the one or more cameras, or a combination thereof, the additional information from the user, wherein the features are extracted from the natural language explanation of the rule or policy and the additional information.

In some embodiments, the operations further include executing the rule or policy based on the control structure, wherein executing comprises evaluating the one or more conditions, and executing the one or more actions based on the evaluation of the one or more conditions.

In some embodiments, a computer-implemented method is provided that includes steps which, when executed, perform part or all of the one or more processes or operations disclosed herein.

In some embodiments, one or more non-transitory computer-readable media are provide for storing computer-readable instructions that, when executed by at least one processing system, cause a system to perform part or all of the one or more processes or operations disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a network environment in accordance with various embodiments.

FIG. 2A is an illustration depicting an example extended reality system that presents and controls user interface elements within an extended reality environment in accordance with various embodiments.

FIG. 2B is an illustration depicting user interface elements in accordance with various embodiments.

FIG. 3A is an illustration of an augmented reality system in accordance with various embodiments.

FIG. 3B is an illustration of a virtual reality system in accordance with various embodiments.

FIG. 4A is an illustration of haptic devices in accordance with various embodiments.

FIG. 4B is an illustration of an exemplary virtual reality environment in accordance with various embodiments.

FIG. 4C is an illustration of an exemplary augmented reality environment in accordance with various embodiments.

FIGS. 5A-5H illustrate various aspects of context aware policies in accordance with various embodiments.

FIG. 6 is a simplified block diagram of a system for executing and authoring policies in accordance with various embodiments.

FIG. 7 is an illustration of an exemplary scenario of a user performing an activity in an extended reality environment in accordance with various embodiments.

FIG. 8 is a simplified block diagram of an architecture for creating or modifying rules or policies in accordance with various embodiments.

FIGS. 9A and 9B are flow charts depicting processes for creating or modifying rules or policies in accordance with various embodiments.

FIGS. 10A and 10B are illustrations showing exemplary user demonstrations for creating or modifying rules or policies in accordance with various embodiments.

FIG. 11 is an illustration of an electronic device in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Extended reality systems are becoming increasingly ubiquitous with applications in many fields such as computer gaming, health and safety, industrial, and education. As a few examples, extended reality systems are being incorporated into mobile devices, gaming consoles, personal computers, movie theaters, and theme parks. Typical extended reality systems include one or more devices for rendering and displaying content to users. As one example, an extended reality system may incorporate an HMD worn by a user and configured to output extended reality content to the user. The extended reality content may be generated in a wholly or partially simulated environment (extended reality environment) that people sense and/or interact with via an electronic system. The simulated environment may be a VR environment, which is designed to be based entirely on computer-generated sensory inputs (e.g., virtual content) for one or more user senses, or a MR environment, which is designed to incorporate sensory inputs (e.g., a view of the physical surroundings) from the physical environment, or a representation thereof, in addition to including computer-generated sensory inputs (e.g., virtual content). Examples of MR include AR and augmented virtuality (AV). An AR environment is a simulated environment in which one or more virtual objects are superimposed over a physical environment, or a representation thereof, or a simulated environment in which a representation of a physical environment is transformed by computer-generated sensory information. An AV environment refers to a simulated environment in which a virtual or computer-generated environment incorporates one or more sensory inputs from the physical environment. In any instance—VR. MR, AR, or AV, during operation, the user typically interacts with the extended reality system to interact with extended reality content.

In many activities undertaken via AR. MR, AR, or VR, users are free to roam through simulated and physical environments that contain information and objects whose visualization and/or sound may be important to a user's experience within the simulated and physical environments. For example, an extended reality system may assist a user with performance of a task in simulated and physical environments by providing them with information about their environment and instructions for performing the task. The activities undertaken via AR. MR, AR, or VR differ from conventional software applications in various ways, including the size of the simulated and physical environments that users can interact with, the importance of the physical environment and how virtual content is integrated with the physical environment, the quantity and range of virtual content that can be presented to the user and modified by the user, and the almost limitless types of interfaces that can be provided to users for interacting in the simulated and physical environments. However, it can be difficult for a user to create rules or policies to enhance their day-to-day life because it may require some understandings in the logic and flow of a program, especially within an extended reality environment.

In order overcome these challenges and others, techniques are disclosed herein for one or more tools for defining and modifying rules and policies using a combination of natural language explanations and virtual or physical demonstrations. The natural language explanations and virtual or physical demonstrations are used to learn or teach an artificial entity to create or modify one or more rules or policies. For example, a user can show and tell their policy and sequence of actions to an extended reality environment device (e.g., AR/MR glasses), as if they were showing another person about how to perform certain actions according to their preferences. The extended reality environment device can capture, stream and process the data that is accessible through various sensors, including the audio and the natural language processed from the audio, the gesturing (e.g., pointing, holding, touching), eye gaze (e.g., the fixation and the saccade), the egocentric video (and the processed location, distance, geometric, and the semantic information in the space that could tell what object the user interacts with and what activity that the user is performing). The present disclosure can leverage artificial intelligence or an artificial entity to recognize the sequences of actions or the policies that the user explained to the extended reality environment device and extract the key information to populate a suggested policy of actions. Thereafter, the user could view and modify the suggested policy.

The artificial entity can include, for example, a virtual assistant configured to control one more other devices (e.g., internet of things devices, smart devices, etc.) within a physical location. The natural language explanations and virtual or physical demonstrations can be provided using an extended reality environment through interaction with one or more extended reality environment configured devices and/or a virtual assistant configured to communicate with one or more extended reality environment configured devices.

The natural language explanations and virtual or physical demonstrations can then be processed and input into a prediction model to create rules or policies. The natural language explanations can include any combination of instructions for executing a rule or policy, including defining parameters related to triggering events, conditions to be satisfied, and actions to be executed by the one more other devices. Similarly, the virtual or physical demonstrations can include any combination of physical interactions, virtual interactions, gestures, etc. for conveying operation of a rule or policy. The natural language explanations and the virtual or physical demonstrations can be combined to improve the accuracy and simplicity of creating or modifying a rule or policy. For example, a user can dictate what they are doing while performing a desired event, condition, and/or action for a rule or policy. The combined natural language explanations and the virtual or physical demonstrations can be processed and analysed to predict one or more rules or policies to be implemented by the one more other devices.

### Extended Reality System Overview

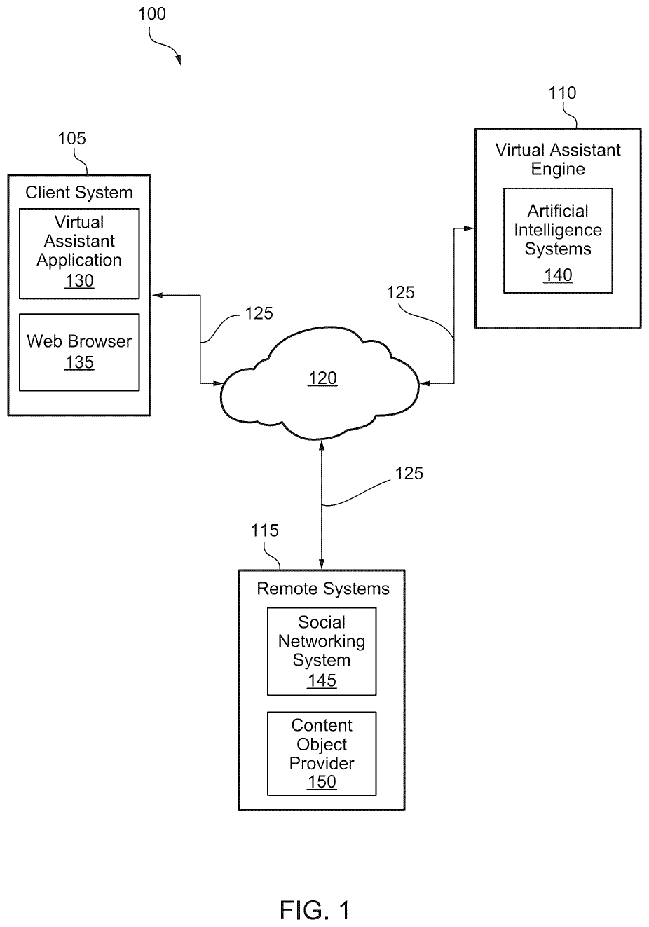

FIG. 1 illustrates an example network environment 100 associated with an extended reality system in accordance with aspects of the present disclosure. Network environment 100 includes a client system 105, a virtual assistant engine 110, and remote systems 115 connected to each other by a network 120. Although FIG. 1 illustrates a particular arrangement of the client system 105, the virtual assistant engine 110, the remote systems 115, and the network 120, this disclosure contemplates any suitable arrangement. As an example, and not by way of limitation, two or more of the client system 105, the virtual assistant engine 110, and the remote systems 115 may be connected to each other directly, bypassing the network 120. As another example, two or more of the client system 105, the virtual assistant engine 110, and the remote systems 115 may be physically or logically co-located with each other in whole or in part. Moreover, although FIG. 1 illustrates a particular number of the client system 105, the virtual assistant engine 110, the remote systems 115, and the network 120, this disclosure contemplates any suitable number of client systems 105, virtual assistant engine 110, remote systems 115, and networks 120. As an example, and not by way of limitation, network environment 100 may include multiple client systems, such as client system 105; virtual assistant engines, such as virtual assistant engine 110; remote systems, such as remote systems 115; and networks, such as network 120.

This disclosure contemplates that network 120 may be any suitable network. As an example, and not by way of limitation, one or more portions of a network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Additionally, the network 120 may include one or more networks.

Links 125 may connect the client system 105, the virtual assistant engine 110, and the remote systems 115 to the network 120, to another communication network (not shown), or to each other. This disclosure contemplates links 125 may include any number and type of suitable links. In particular embodiments, one or more of the links 125 include one or more wireline links (e.g., Digital Subscriber Line or Data Over Cable Service Interface Specification), wireless links (e.g., Wi-Fi or Worldwide Interoperability for Microwave Access), or optical links (e.g., Synchronous Optical Network or Synchronous Digital Hierarchy). In particular embodiments, each link of the links 125 includes an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 125, or a combination of two or more such links. Links 125 need not necessarily be the same throughout a network environment 100. For example, some links of the links 125 may differ in one or more respects from some other links of the links 125.

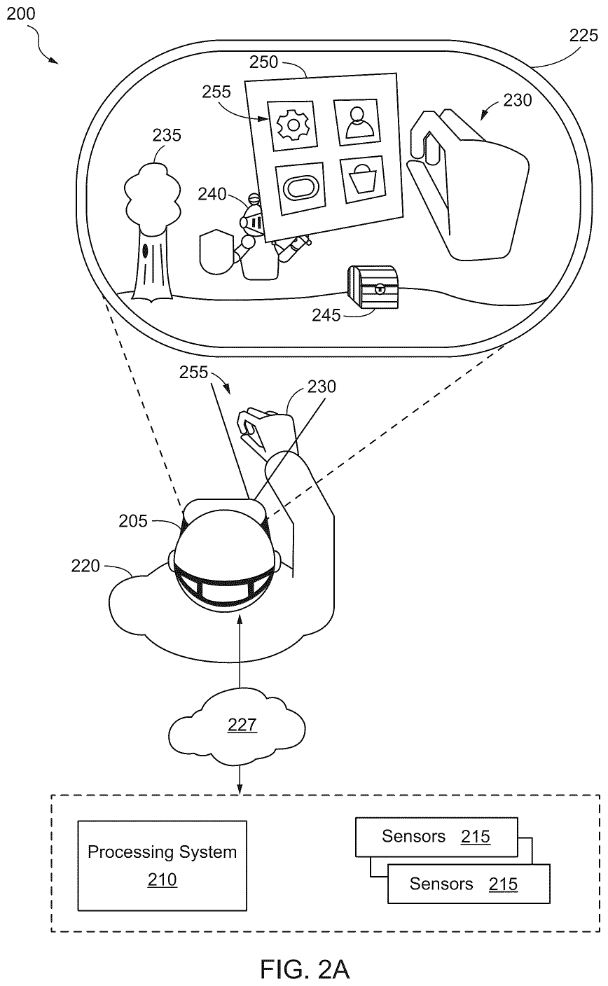

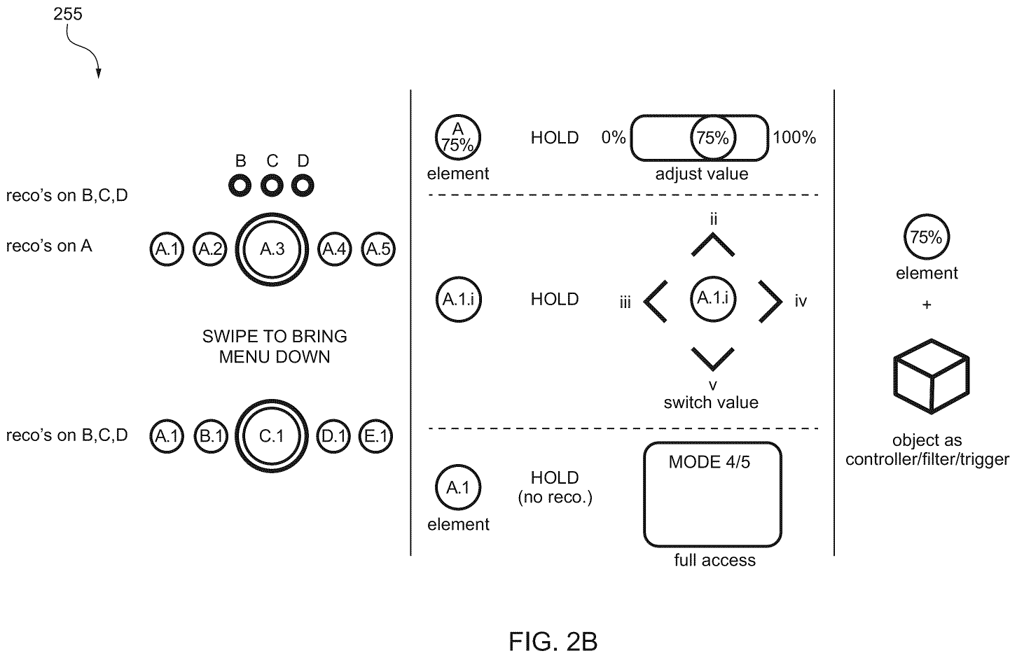

In various embodiments, the client system 105 is an electronic device including hardware, software, or embedded logic components or a combination of two or more such components and capable of carrying out the appropriate extended reality functionalities in accordance with techniques of the disclosure. As an example, and not by way of limitation, the client system 105 may include a desktop computer, notebook or laptop computer, netbook, a tablet computer, e-book reader, global positioning system (GPS) device, camera, personal digital assistant, handheld electronic device, cellular telephone, smartphone, a VR, MR, AR, or AV headset or HMD, any suitable electronic device capable of displaying extended reality content, or any suitable combination thereof. In particular embodiments, the client system 105 is a VR/AR HMD, such as described in detail with respect to FIG. 2. This disclosure contemplates any suitable client system 105 that is configured to generate and output extended reality content to the user. The client system 105 may enable its user to communicate with other users at other client systems.

In various embodiments, the client system 105 includes a virtual assistant application 130. The virtual assistant application 130 instantiates at least a portion of a virtual assistant, which can provide information or services to a user based on user input, contextual awareness (such as clues from the physical environment or clues from user behavior), and the capability to access information from a variety of online sources (such as weather conditions, traffic information, news, stock prices, user schedules, and/or retail prices). As used herein, when an action is “based on” something, this means the action is based at least in part on at least a part of the something. The user input may include text (e.g., online chat), especially in an instant messaging application or other applications, voice, eye-tracking, user motion, such as gestures or running, or a combination of them. The virtual assistant may perform concierge-type services (e.g., making dinner reservations, purchasing event tickets, making travel arrangements, and the like), provide information (e.g., reminders, information concerning an object in an environment, information concerning a task or interaction, answers to questions, training regarding a task or activity, and the like), provide goal assisted services (e.g., generating and implementing a recipe to cook a meal in a certain amount of time, implementing tasks to clean in a most efficient manner, generating and executing a construction plan including allocation of tasks to two or more workers, and the like), execute policies in accordance with context aware policies (CAPs), and similar types of extended reality services. The virtual assistant may also perform management or data-handling tasks based on online information and events without user initiation or interaction. Examples of those tasks that may be performed by the virtual assistant may include schedule management (e.g., sending an alert to a dinner date to which a user is running late due to traffic conditions, updating schedules for both parties, and changing the restaurant reservation time). The virtual assistant may be enabled in an extended reality environment by a combination of the client system 105, the virtual assistant engine 110, application programming interfaces (APIs), and the proliferation of applications on user devices, such as the remote systems 115.

A user at the client system 105 may use the virtual assistant application 130 to interact with the virtual assistant engine 110. In some instances, the virtual assistant application 130 is a stand-alone application or integrated into another application, such as a social-networking application or another suitable application (e.g., an artificial simulation application). In some instances, the virtual assistant application 130 is integrated into the client system 105 (e.g., part of the operating system of the client system 105), an assistant hardware device, or any other suitable hardware devices. In some instances, the virtual assistant application 130 may be accessed via a web browser 135. In some instances, the virtual assistant application 130 passively listens to and observes interactions of the user in the real-world, and processes what it hears and sees (e.g., explicit input, such as audio commands or interface commands, contextual awareness derived from audio or physical actions of the user, objects in the real-world, environmental triggers such as weather or time, and the like) in order to interact with the user in an intuitive manner.

In particular embodiments, the virtual assistant application 130 receives or obtains input from a user, the physical environment, a virtual reality environment, or a combination thereof via different modalities. As an example, and not by way of limitation, the modalities may include audio, text, image, video, motion, graphical or virtual user interfaces, orientation, and/or sensors. The virtual assistant application 130 communicates the input to the virtual assistant engine 110. Based on the input, the virtual assistant engine 110 analyzes the input and generates responses (e.g., text or audio responses, device commands, such as a signal to turn on a television, virtual content such as a virtual object, or the like) as output. The virtual assistant engine 110 may send the generated responses to the virtual assistant application 130, the client system 105, the remote systems 115, or a combination thereof. The virtual assistant application 130 may present the response to the user at the client system 105 (e.g., rendering virtual content overlaid on a real-world object within the display). The presented responses may be based on different modalities, such as audio, text, image, and video. As an example, and not by way of limitation, context concerning activity of a user in the physical world may be analyzed and determined to initiate an interaction for completing an immediate task or goal, which may include the virtual assistant application 130 retrieving traffic information (e.g., via remote systems 115). The virtual assistant application 130 may communicate the request for traffic information to virtual assistant engine 110. The virtual assistant engine 110 may accordingly contact a third-party system and retrieve traffic information as a result of the request and send the traffic information back to the virtual assistant application 110. The virtual assistant application 110 may then present the traffic information to the user as text (e.g., as virtual content overlaid on the physical environment, such as real-world object) or audio (e.g., spoken to the user in natural language through a speaker associated with the client system 105).

In some embodiments, the client system 105 may collect or otherwise be associated with data. In some embodiments, the data may be collected from or pertain to any suitable computing system or application (e.g., a social-networking system, other client systems, a third-party system, a messaging application, a photo-sharing application, a biometric data acquisition application, an artificial-reality application, a virtual assistant application).

In some embodiments, privacy settings (or “access settings”) may be provided for the data. The privacy settings may be stored in any suitable manner (e.g., stored in an index on an authorization server). A privacy setting for the data may specify how the data or particular information associated with the data can be accessed, stored, or otherwise used (e.g., viewed, shared, modified, copied, executed, surfaced, or identified) within an application (e.g., an extended reality application). When the privacy settings for the data allow a particular user or other entity to access that the data, the data may be described as being “visible” with respect to that user or other entity. For example, a user of an extended reality application or virtual assistant application may specify privacy settings for a user profile page that identifies a set of users that may access the extended reality application or virtual assistant application information on the user profile page and excludes other users from accessing that information. As another example, an extended reality application or virtual assistant application may store privacy policies/guidelines. The privacy policies/guidelines may specify what information of users may be accessible by which entities and/or by which processes (e.g., internal research, advertising algorithms, machine-learning algorithms) to ensure only certain information of the user may be accessed by certain entities or processes.

In some embodiments, privacy settings for the data may specify a “blocked list” of users or other entities that should not be allowed to access certain information associated with the data. In some cases, the blocked list may include third-party entities. The blocked list may specify one or more users or entities for which the data is not visible.

In some embodiments, privacy settings associated with the data may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different pieces of the data of the same type associated with a user may have different privacy settings. In addition, one or more default privacy settings may be set for each piece of data of a particular data type.

In various embodiments, the virtual assistant engine 110 assists users to retrieve information from different sources, request services from different service providers, assist users to learn or complete goals and tasks using different sources and/or service providers, execute policies or services, and combinations thereof. In some instances, the virtual assistant engine 110 receives input data from the virtual assistant application 130 and determines one or more interactions based on the input data that could be executed to request information, services, and/or complete a goal or task of the user. The interactions are actions that could be presented to a user for execution in an extended reality environment. In some instances, the interactions are influenced by other actions associated with the user. The interactions are aligned with affordances, goals, or tasks associated with the user. Affordances may include actions or services associated with smart home devices, extended reality applications, web services, and the like. Goals may include things that a user wants to occur or desires (e.g., as a meal, a piece of furniture, a repaired automobile, a house, a garden, a clean apartment, and the like). Tasks may include things that need to be done or activities that should be carried out in order to accomplish a goal or carry out an aim (e.g., cooking a meal using one or more recipes, building a piece of furniture, repairing a vehicle, building a house, planting a garden, cleaning one or more rooms of an apartment, and the like). Each goal and task may be associated with a workflow of actions or sub-tasks for performing the task and achieving the goal. For example, for preparing a salad, a workflow of actions or sub-tasks may include the ingredients needed, equipment needed for the steps (e.g., a knife, a stove top, a pan, a salad spinner), sub-tasks for preparing ingredients (e.g., chopping onions, cleaning lettuce, cooking chicken), and sub-tasks for combining ingredients into subcomponents (e.g., cooking chicken with olive oil and Italian seasonings).

The virtual assistant engine 110 may use artificial intelligence (AI) systems 140 (e.g., rule-based systems and/or machine-learning based systems) to analyze the input based on a user's profile and other relevant information. The result of the analysis may include different interactions associated with an affordance, task, or goal of the user. The virtual assistant engine 110 may then retrieve information, request services, and/or generate instructions, recommendations, or virtual content associated with one or more of the different interactions for executing the actions associated with the affordances and/or completing tasks or goals. In some instances, the virtual assistant engine 110 interacts with remote systems 115, such as a social-networking system 145 when retrieving information, requesting service, and/or generating instructions or recommendations for the user. The virtual assistant engine 110 may generate virtual content for the user using various techniques, such as natural language generating, virtual object rendering, and the like. The virtual content may include, for example, the retrieved information; the status of the requested services; a virtual object, such as a glimmer overlaid on a physical object such as an appliance, light, or piece of exercise equipment; a demonstration for a task, and the like. In particular embodiments, the virtual assistant engine 110 enables the user to interact with it regarding the information, services, or goals using a graphical or virtual interface, a stateful and multi-turn conversation using dialog-management techniques, and/or a stateful and multi-action interaction using task-management techniques.

In various embodiments, remote systems 115 may include one or more types of servers, one or more data stores, one or more interfaces, including but not limited to APIs, one or more web services, one or more content sources, one or more networks, or any other suitable components, e.g., that servers may communicate with. A remote system 115 may be operated by a same entity or a different entity from an entity operating the virtual assistant engine 110. In particular embodiments, however, the virtual assistant engine 110 and third-party systems may operate in conjunction with each other to provide virtual content to users of the client system 105. For example, a social-networking system 145 may provide a platform, or backbone, which other systems, such as third-party systems, may use to provide social-networking services and functionality to users across the Internet, and the virtual assistant engine 110 may access these systems to provide virtual content on the client system 105.

In particular embodiments, the social-networking system 145 may be a network-addressable computing system that can host an online social network. The social-networking system 145 may generate, store, receive, and send social-networking data, such as user-profile data, concept-profile data, social-graph information, or other suitable data related to the online social network. The social-networking system 145 may be accessed by the other components of network environment 100 either directly or via a network 120. As an example, and not by way of limitation, the client system 105 may access the social-networking system 145 using a web browser 135, or a native application associated with the social-networking system 145 (e.g., a mobile social-networking application, a messaging application, another suitable application, or any combination thereof) either directly or via a network 120. The social-networking system 145 may provide users with the ability to take actions on various types of items or objects, supported by the social-networking system 145. As an example, and not by way of limitation, the items and objects may include groups or social networks to which users of the social-networking system 145 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 145 or by an external system of the remote systems 115, which is separate from the social-networking system 145 and coupled to the social-networking system via the network 120.

Remote systems 115 may include a content object provider 150. A content object provider 150 includes one or more sources of virtual content objects, which may be communicated to the client system 105. As an example, and not by way of limitation, virtual content objects may include information regarding things or activities of interest to the user, such as movie show times, movie reviews, restaurant reviews, restaurant menus, product information and reviews, instructions on how to perform various tasks, exercise regimens, cooking recipes, or other suitable information. As another example and not by way of limitation, content objects may include incentive content objects, such as coupons, discount tickets, gift certificates, or other suitable incentive objects. As another example and not by way of limitation, content objects may include virtual objects, such as virtual interfaces, two-dimensional (2D) or three-dimensional (3D) graphics, media content, or other suitable virtual objects.

FIG. 2A illustrates an example client system 200 (e.g., client system 105 described with respect to FIG. 1) in accordance with aspects of the present disclosure. Client system 200 includes an extended reality system 205 (e.g., an HMD), a processing system 210, and one or more sensors 215. As shown, extended reality system 205 is typically worn by user 220 and includes an electronic display (e.g., a transparent, translucent, or solid display), optional controllers, and optical assembly for presenting extended reality content 225 to the user 220. The one or more sensors 215 may include motion sensors (e.g., accelerometers) for tracking motion of the extended reality system 205 and may include one or more image capturing devices (e.g., cameras, line scanners) for capturing images and other information of the surrounding physical environment. In this example, processing system 210 is shown as a single computing device, such as a gaming console, workstation, a desktop computer, or a laptop. In other examples, processing system 210 may be distributed across a plurality of computing devices, such as a distributed computing network, a data center, or a cloud computing system. In other examples, processing system 210 may be integrated with the HMD. Extended reality system 205, processing system 210, and the one or more sensors 215 are communicatively coupled via a network 227, which may be a wired or wireless network, such as Wi-Fi, a mesh network, or a short-range wireless communication medium, such as Bluetooth wireless technology, or a combination thereof. Although extended reality system 205 is shown in this example as in communication with, e.g., tethered to or in wireless communication with, the processing system 210, in some implementations, extended reality system 205 operates as a stand-alone, mobile extended reality system.

In general, client system 200 uses information captured from a real-world, physical environment to render extended reality content 225 for display to the user 220. In the example of FIG. 2A, the user 220 views the extended reality content 225 constructed and rendered by an extended reality application executing on processing system 210 and/or extended reality system 205. In some examples, the extended reality content 225 viewed through the extended reality system 205 includes a mixture of real-world imagery (e.g., the user's hand 230 and physical objects 235) and virtual imagery (e.g., virtual content, such as information or objects 240, 245 and virtual user interface 250) to produce mixed reality and/or augmented reality. In some examples, virtual information or objects 240, 245 may be mapped (e.g., pinned, locked, placed) to a particular position within extended reality content 225. For example, a position for virtual information or objects 240, 245 may be fixed, as relative to one of walls of a residence or surface of the earth, for instance. A position for virtual information or objects 240, 245 may be variable, as relative to a physical object 235 or the user 220, for instance. In some examples, the particular position of virtual information or objects 240, 245 within the extended reality content 225 is associated with a position within the real world, physical environment (e.g., on a surface of a physical object 235).

In the example shown in FIG. 2A, virtual information or objects 240, 245 are mapped at a position relative to a physical object 235. As should be understood, the virtual imagery (e.g., virtual content, such as information or objects 240, 245 and virtual user interface 250) does not exist in the real-world, physical environment. Virtual user interface 250 may be fixed, as relative to the user 220, the user's hand 230, physical objects 235, or other virtual content, such as virtual information or objects 240, 245, for instance. As a result, client system 200 renders, at a user interface position that is locked relative to a position of the user 220, the user's hand 230, physical objects 235, or other virtual content in the extended reality environment, virtual user interface 250 for display at extended reality system 205 as part of extended reality content 225. As used herein, a virtual element ‘locked’ to a position of virtual content or a physical object is rendered at a position relative to the position of the virtual content or physical object so as to appear to be part of or otherwise tied in the extended reality environment to the virtual content or physical object.

In some implementations, the client system 200 generates and renders virtual content (e.g., GIFs, photos, applications, live-streams, videos, text, a web-browser, drawings, animations, representations of data files, or any other visible media) on a virtual surface. A virtual surface may be associated with a planar or other real-world surface (e.g., the virtual surface corresponds to and is locked to a physical surface, such as a wall, table, or ceiling). In the example shown in FIG. 2A, the virtual surface is associated with the sky and ground of the physical environment. In other examples, a virtual surface can be associated with a portion of a surface (e.g., a portion of the wall). In some examples, only the virtual content items contained within a virtual surface are rendered. In other examples, the virtual surface is generated and rendered (e.g., as a virtual plane or as a border corresponding to the virtual surface). In some examples, a virtual surface can be rendered as floating in a virtual or real-world physical environment (e.g., not associated with a particular real-world surface). The client system 200 may render one or more virtual content items in response to a determination that at least a portion of the location of virtual content items is in a field of view of the user 220. For example, client system 200 may render virtual user interface 250 only if a given physical object (e.g., a lamp) is within the field of view of the user 220.

During operation, the extended reality application constructs extended reality content 225 for display to user 220 by tracking and computing interaction information (e.g., tasks for completion) for a frame of reference, typically a viewing perspective of extended reality system 205. Using extended reality system 205 as a frame of reference and based on a current field of view as determined by a current estimated interaction of extended reality system 205, the extended reality application renders extended reality content 225 which, in some examples, may be overlaid, at least in part, upon the real-world, physical environment of the user 220. During this process, the extended reality application uses sensed data received from extended reality system 205 and sensors 215, such as movement information, contextual awareness, and/or user commands, and, in some examples, data from any external sensors, such as third-party information or device, to capture information within the real world, physical environment, such as motion by user 220 and/or feature tracking information with respect to user 220. Based on the sensed data, the extended reality application determines interaction information to be presented for the frame of reference of extended reality system 205 and, in accordance with the current context of the user 220, renders the extended reality content 225.

Client system 200 may trigger generation and rendering of virtual content based on a current field of view of user 220, as may be determined by real-time gaze 265 tracking of the user, or other conditions. More specifically, image capture devices of the sensors 215 capture image data representative of objects in the real-world, physical environment that are within a field of view of image capture devices. During operation, the client system 200 performs object recognition within images captured by the image capturing devices of extended reality system 205 to identify objects in the physical environment, such as the user 220, the user's hand 230, and/or physical objects 235. Further, the client system 200 tracks the position, orientation, and configuration of the objects in the physical environment over a sliding window of time. Field of view typically corresponds with the viewing perspective of the extended reality system 205. In some examples, the extended reality application presents extended reality content 225 that includes mixed reality and/or augmented reality.

As illustrated in FIG. 2A, the extended reality application may render virtual content, such as virtual information or objects 240, 245 on a transparent display such that the virtual content is overlaid on real-world objects, such as the portions of the user 220, the user's hand 230, or physical objects 235, that are within a field of view of the user 220. In other examples, the extended reality application may render images of real-world objects, such as the portions of the user 220, the user's hand 230, or physical objects 235, that are within a field of view along with virtual objects, such as virtual information or objects 240, 245 within extended reality content 225. In other examples, the extended reality application may render virtual representations of the portions of the user 220, the user's hand 230, and physical objects 235 that are within a field of view (e.g., render real-world objects as virtual objects) within extended reality content 225. In either example, user 220 is able to view the portions of the user 220, the user's hand 230, physical objects 235 and/or any other real-world objects or virtual content that are within a field of view within extended reality content 225. In other examples, the extended reality application may not render representations of the user 220 and the user's hand 230; the extended reality application may instead only render the physical objects 235 and/or virtual information or objects 240, 245.

In various embodiments, the client system 200 renders to extended reality system 205 extended reality content 225 in which virtual user interface 250 is locked relative to a position of the user 220, the user's hand 230, physical objects 235, or other virtual content in the extended reality environment. That is, the client system 205 may render a virtual user interface 250 having one or more virtual user interface elements at a position and orientation that are based on and correspond to the position and orientation of the user 220, the user's hand 230, physical objects 235, or other virtual content in the extended reality environment. For example, if a physical object is positioned in a vertical position on a table, the client system 205 may render the virtual user interface 250 at a location corresponding to the position and orientation of the physical object in the extended reality environment. Alternatively, if the user's hand 230 is within the field of view, the client system 200 may render the virtual user interface at a location corresponding to the position and orientation of the user's hand 230 in the extended reality environment. Alternatively, if other virtual content is within the field of view, the client system 200 may render the virtual user interface at a location corresponding to a general predetermined position of the field of view (e.g., a bottom of the field of view) in the extended reality environment. Alternatively, if other virtual content is within the field of view, the client system 200 may render the virtual user interface at a location corresponding to the position and orientation of the other virtual content in the extended reality environment. In this way, the virtual user interface 250 being rendered in the virtual environment may track the user 220, the user's hand 230, physical objects 235, or other virtual content such that the user interface appears, to the user, to be associated with the user 220, the user's hand 230, physical objects 235, or other virtual content in the extended reality environment.

As shown in FIGS. 2A and 2B, virtual user interface 250 includes one or more virtual user interface elements. Virtual user interface elements may include, for instance, a virtual drawing interface; a selectable menu (e.g., a drop-down menu); virtual buttons, such as button element 255; a virtual slider or scroll bar; a directional pad; a keyboard; other user-selectable user interface elements including glyphs, display elements, content, user interface controls, and so forth. The particular virtual user interface elements for virtual user interface 250 may be context-driven based on the current extended reality applications engaged by the user 220 or real-world actions/tasks being performed by the user 220. When a user performs a user interface gesture in the extended reality environment at a location that corresponds to one of the virtual user interface elements of virtual user interface 250, the client system 200 detects the gesture relative to the virtual user interface elements and performs an action associated with the gesture and the virtual user interface elements. For example, the user 220 may press their finger at a button element 255 location on the virtual user interface 250. The button element 255 and/or virtual user interface 250 location may or may not be overlaid on the user 220, the user's hand 230, physical objects 235, or other virtual content, e.g., correspond to a position in the physical environment, such as on a light switch or controller at which the client system 200 renders the virtual user interface button. In this example, the client system 200 detects this virtual button press gesture and performs an action corresponding to the detected press of a virtual user interface button (e.g., turns the light on). The client system 205 may also, for instance, animate a press of the virtual user interface button along with the button press gesture.

The client system 200 may detect user interface gestures and other gestures using an inside-out or outside-in tracking system of image capture devices and or external cameras. The client system 200 may alternatively, or in addition, detect user interface gestures and other gestures using a presence-sensitive surface. That is, a presence-sensitive interface of the extended reality system 205 and/or controller may receive user inputs that make up a user interface gesture. The extended reality system 205 and/or controller may provide haptic feedback to touch-based user interaction by having a physical surface with which the user can interact (e.g., touch, drag a finger across, grab, and so forth). In addition, peripheral extended reality system 205 and/or controller may output other indications of user interaction using an output device. For example, in response to a detected press of a virtual user interface button, extended reality system 205 and/or controller may output a vibration or “click” noise, or extended reality system 205 and/or controller may generate and output content to a display. In some examples, the user 220 may press and drag their finger along physical locations on the extended reality system 205 and/or controller corresponding to positions in the virtual environment at which the client system 205 renders virtual user interface elements of virtual user interface 250. In this example, the client system 205 detects this gesture and performs an action according to the detected press and drag of virtual user interface elements, such as by moving a slider bar in the virtual environment. In this way, client system 200 simulates movement of virtual content using virtual user interface elements and gestures.

Various embodiments disclosed herein may include or be implemented in conjunction with various types of extended reality systems. Extended reality content generated by the extended reality systems may include completely computer-generated content or computer-generated content combined with captured (e.g., real-world) content. The extended reality content may include video, audio, haptic feedback, or some combination thereof, any of which may be presented in a single channel or in multiple channels (e.g., stereo video that produces a 3D effect to the viewer). Additionally, in some embodiments, extended reality may also be associated with applications, products, accessories, services, or some combination thereof, that are used to, for example, create content in an extended reality and/or are otherwise used in (e.g., to perform activities in) an extended reality.

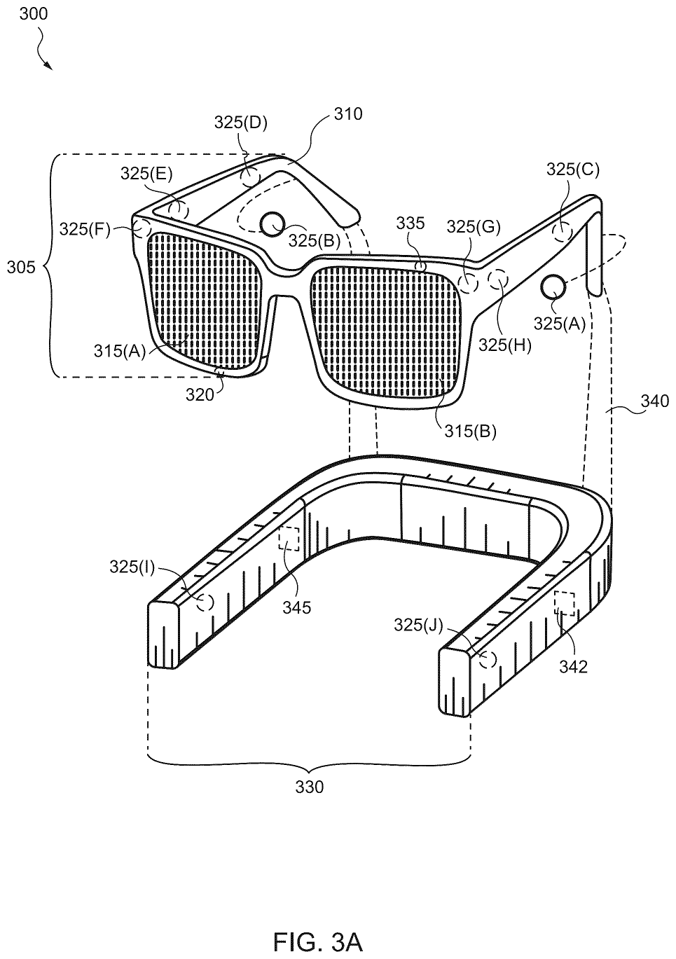

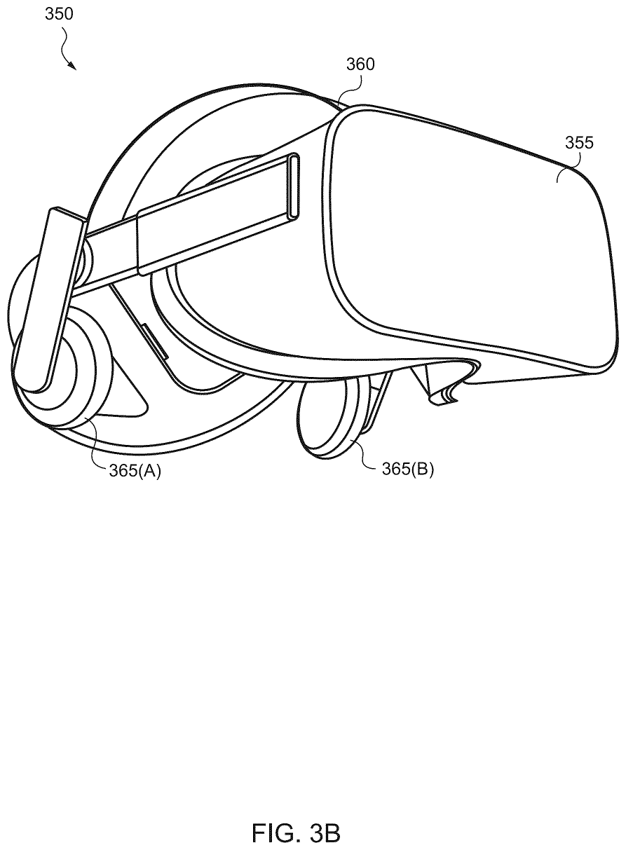

The extended reality systems may be implemented in a variety of different form factors and configurations. Some extended reality systems may be designed to work without near-eye displays (NEDs). Other extended reality systems may include an NED that also provides visibility into the real world (e.g., augmented reality system 300 in FIG. 3A) or that visually immerses a user in an extended reality (e.g., virtual reality system 350 in FIG. 3B). While some extended reality devices may be self-contained systems, other extended reality devices may communicate and/or coordinate with external devices to provide an extended reality experience to a user. Examples of such external devices include handheld controllers, mobile devices, desktop computers, devices worn by a user, devices worn by one or more other users, and/or any other suitable external system.

As shown in FIG. 3A, augmented reality system 300 may include an eyewear device 305 with a frame 310 configured to hold a left display device 315(A) and a right display device 315(B) in front of a user's eyes. Display devices 315(A) and 315(B) may act together or independently to present an image or series of images to a user. While augmented reality system 300 includes two displays, embodiments of this disclosure may be implemented in augmented reality systems with a single NED or more than two NEDs.

In some embodiments, augmented reality system 300 may include one or more sensors, such as sensor 320. Sensor 320 may generate measurement signals in response to motion of augmented reality system 300 and may be located on substantially any portion of frame 310. Sensor 320 may represent one or more of a variety of different sensing mechanisms, such as a position sensor, an inertial measurement unit (IMU), a depth camera assembly, a structured light emitter and/or detector, or any combination thereof. In some embodiments, augmented reality system 300 may or may not include sensor 320 or may include more than one sensor. In embodiments in which sensor 320 includes an IMU, the IMU may generate calibration data based on measurement signals from sensor 320. Examples of sensor 320 may include, without limitation, accelerometers, gyroscopes, magnetometers, other suitable types of sensors that detect motion, sensors used for error correction of the IMU, or some combination thereof.

In some examples, augmented reality system 300 may also include a microphone array with a plurality of acoustic transducers 325(A)-325(J), referred to collectively as acoustic transducers 325. Acoustic transducers 325 may represent transducers that detect air pressure variations induced by sound waves. Each acoustic transducer 325 may be configured to detect sound and convert the detected sound into an electronic format (e.g., an analog or digital format). The microphone array in FIG. 3A may include, for example, ten acoustic transducers: 325(A) and 325(B), which may be designed to be placed inside a corresponding ear of the user, acoustic transducers 325(C), 325(D), 325(E), 325(F), 325(G), and 325(H), which may be positioned at various locations on frame 310, and/or acoustic transducers 325(I) and 325(J), which may be positioned on a corresponding neckband 330.

In some embodiments, one or more of acoustic transducers 325(A)—(J) may be used as output transducers (e.g., speakers). For example, acoustic transducers 325(A) and/or 325(B) may be earbuds or any other suitable type of headphone or speaker. The configuration of acoustic transducers 325 of the microphone array may vary. While augmented reality system 300 is shown in FIG. 3A as having ten acoustic transducers, the number of acoustic transducers 325 may be greater or less than ten. In some embodiments, using higher numbers of acoustic transducers 325 may increase the amount of audio information collected and/or the sensitivity and accuracy of the audio information. In contrast, using a lower number of acoustic transducers 325 may decrease the computing power required by an associated controller 335 to process the collected audio information. In addition, the position of each acoustic transducer 325 of the microphone array may vary. For example, the position of an acoustic transducer 325 may include a defined position on the user, a defined coordinate on frame 310, an orientation associated with each acoustic transducer 325, or some combination thereof.

Acoustic transducers 325(A) and 325(B) may be positioned on different parts of the user's ear, such as behind the pinna, behind the tragus, and/or within the auricle or fossa. Alternatively, or additionally, there may be additional acoustic transducers 325 on or surrounding the ear in addition to acoustic transducers 325 inside the ear canal. Having an acoustic transducer 325 positioned next to an ear canal of a user may enable the microphone array to collect information on how sounds arrive at the ear canal. By positioning at least two of acoustic transducers 325 on either side of a user's head (e.g., as binaural microphones), augmented reality system 300 may simulate binaural hearing and capture a 3D stereo sound field around a user's head. In some embodiments, acoustic transducers 325(A) and 325(B) may be connected to augmented reality system 300 via a wired connection 340, and in other embodiments acoustic transducers 325(A) and 325(B) may be connected to augmented reality system 300 via a wireless connection (e.g., a Bluetooth connection). In still other embodiments, acoustic transducers 325(A) and 325(B) may not be used at all in conjunction with augmented reality system 300.

Acoustic transducers 325 on frame 310 may be positioned in a variety of different ways, including along the length of the temples, across the bridge, above or below display devices 315(A) and 315(B), or some combination thereof. Acoustic transducers 325 may also be oriented such that the microphone array is able to detect sounds in a wide range of directions surrounding the user wearing the augmented reality system 300. In some embodiments, an optimization process may be performed during manufacturing of augmented reality system 300 to determine relative positioning of each acoustic transducer 325 in the microphone array.

In some examples, augmented reality system 300 may include or be connected to an external device (e.g., a paired device), such as neckband 330. Neckband 330 generally represents any type or form of paired device. Thus, the following discussion of neckband 330 may also apply to various other paired devices, such as charging cases, smart watches, smart phones, wrist bands, other wearable devices, hand-held controllers, tablet computers, laptop computers, and/or other external computing devices.

As shown, neckband 330 may be coupled to eyewear device 305 via one or more connectors. The connectors may be wired or wireless and may include electrical and/or non-electrical (e.g., structural) components. In some cases, eyewear device 305 and neckband 330 may operate independently without any wired or wireless connection between them. While FIG. 3A illustrates the components of eyewear device 305 and neckband 330 in example locations on eyewear device 305 and neckband 330, the components may be located elsewhere and/or distributed differently on eyewear device 305 and/or neckband 330. In some embodiments, the components of eyewear device 305 and neckband 330 may be located on one or more additional peripheral devices paired with eyewear device 305, neckband 330, or some combination thereof.

Pairing external devices, such as neckband 330, with augmented reality eyewear devices may enable the eyewear devices to achieve the form factor of a pair of glasses while still providing sufficient battery and computation power for expanded capabilities. Some or all of the battery power, computational resources, and/or additional features of augmented reality system 300 may be provided by a paired device or shared between a paired device and an eyewear device, thus reducing the weight, heat profile, and form factor of the eyewear device overall while still retaining desired functionality. For example, neckband 330 may allow components that would otherwise be included on an eyewear device to be included in neckband 330 since users may tolerate a heavier weight load on their shoulders than they would tolerate on their heads. Neckband 330 may also have a larger surface area over which to diffuse and disperse heat to the ambient environment. Thus, neckband 330 may allow for greater battery and computation capacity than might otherwise have been possible on a stand-alone eyewear device. Since weight carried in neckband 330 may be less invasive to a user than weight carried in eyewear device 305, a user may tolerate wearing a lighter eyewear device and carrying or wearing the paired device for greater lengths of time than a user would tolerate wearing a heavy standalone eyewear device, thereby enabling users to incorporate extended reality environments more fully into their day-to-day activities.

Neckband 330 may be communicatively coupled with eyewear device 305 and/or to other devices. These other devices may provide certain functions (e.g., tracking, localizing, depth mapping, processing, storage) to augmented reality system 300. In the embodiment of FIG. 3A, neckband 330 may include two acoustic transducers (e.g., 325(I) and 325(J)) that are part of the microphone array (or potentially form their own microphone subarray). Neckband 330 may also include a controller 342 and a power source 345.

Acoustic transducers 325(I) and 325(J) of neckband 330 may be configured to detect sound and convert the detected sound into an electronic format (analog or digital). In the embodiment of FIG. 3A, acoustic transducers 325(I) and 325(J) may be positioned on neckband 330, thereby increasing the distance between the neckband acoustic transducers 325(I) and 325(J) and other acoustic transducers 325 positioned on eyewear device 305. In some cases, increasing the distance between acoustic transducers 325 of the microphone array may improve the accuracy of beamforming performed via the microphone array. For example, if a sound is detected by acoustic transducers 325(C) and 325(D) and the distance between acoustic transducers 325(C) and 325(D) is greater than, e.g., the distance between acoustic transducers 325(D) and 325(E), the determined source location of the detected sound may be more accurate than if the sound had been detected by acoustic transducers 325(D) and 325(E).

Controller 342 of neckband 330 may process information generated by the sensors on neckband 330 and/or augmented reality system 300. For example, controller 342 may process information from the microphone array that describes sounds detected by the microphone array. For each detected sound, controller 342 may perform a direction-of-arrival (DOA) estimation to estimate a direction from which the detected sound arrived at the microphone array. As the microphone array detects sounds, controller 342 may populate an audio data set with the information. In embodiments in which augmented reality system 300 includes an inertial measurement unit, controller 342 may compute all inertial and spatial calculations from the IMU located on eyewear device 305. A connector may convey information between augmented reality system 300 and neckband 330 and between augmented reality system 300 and controller 342. The information may be in the form of optical data, electrical data, wireless data, or any other transmittable data form. Moving the processing of information generated by augmented reality system 300 to neckband 330 may reduce weight and heat in eyewear device 305, making it more comfortable to the user.

Power source 345 in neckband 330 may provide power to eyewear device 305 and/or to neckband 330. Power source 345 may include, without limitation, lithium-ion batteries, lithium-polymer batteries, primary lithium batteries, alkaline batteries, or any other form of power storage. In some cases, power source 345 may be a wired power source. Including power source 345 on neckband 330 instead of on eyewear device 305 may help better distribute the weight and heat generated by power source 345.

As noted, some extended reality systems may, instead of blending an extended reality with actual reality, substantially replace one or more of a user's sensory perceptions of the real world with a virtual experience. One example of this type of system is a head-worn display system, such as virtual reality system 350 in FIG. 3B, that mostly or completely covers a user's field of view. Virtual reality system 350 may include a front rigid body 355 and a band 360 shaped to fit around a user's head. Virtual reality system 350 may also include output audio transducers 365(A) and 365(B). Furthermore, while not shown in FIG. 3B, front rigid body 355 may include one or more electronic elements, including one or more electronic displays, one or more inertial measurement units (IMUs), one or more tracking emitters or detectors, and/or any other suitable device or system for creating an extended reality experience.

Extended reality systems may include a variety of types of visual feedback mechanisms. For example, display devices in augmented reality system 300 and/or virtual reality system 350 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These extended reality systems may include a single display screen for both eyes or may provide a display screen for each eye, which may allow for additional flexibility for varifocal adjustments or for correcting a user's refractive error. Some of these extended reality systems may also include optical subsystems having one or more lenses (e.g., conventional concave or convex lenses, Fresnel lenses, adjustable liquid lenses) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (e.g., a single lens configuration that directly collimates light but results in so-called pincushion distortion) and/or a pupil-forming architecture (e.g., a multi-lens configuration that produces so-called barrel distortion to nullify pincushion distortion).

In addition to or instead of using display screens, some of the extended reality systems described herein may include one or more projection systems. For example, display devices in augmented reality system 300 and/or virtual reality system 350 may include micro-LED projectors that project light (using, e.g., a waveguide) into display devices, such as clear combiner lenses that allow ambient light to pass through. The display devices may refract the projected light toward a user's pupil and may enable a user to simultaneously view both extended reality content and the real world. The display devices may accomplish this using any of a variety of different optical components, including waveguide components (e.g., holographic, planar, diffractive, polarized, and/or reflective waveguide elements), light-manipulation surfaces and elements (e.g., diffractive, reflective, and refractive elements and gratings), and/or coupling elements. Extended reality systems may also be configured with any other suitable type or form of image projection system, such as retinal projectors used in virtual retina displays.

The extended reality systems described herein may also include various types of computer vision components and subsystems. For example, augmented reality system 300 and/or virtual reality system 350 may include one or more optical sensors, such as 2D or 3D cameras, structured light transmitters and detectors, time-of-flight depth sensors, single-beam or sweeping laser rangefinders, 3D LiDAR sensors, and/or any other suitable type or form of optical sensor. An extended reality system may process data from one or more of these sensors to identify a location of a user, to map the real world, to provide a user with context about real-world surroundings, and/or to perform a variety of other functions.

The extended reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the extended reality systems described herein may also include tactile (e.g., haptic) feedback systems, which may be incorporated into headwear, gloves, body suits, handheld controllers, environmental devices (e.g., chairs, floormats), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other extended reality devices, within other extended reality devices, and/or in conjunction with other extended reality devices.

By providing haptic sensations, audible content, and/or visual content, extended reality systems may create an entire virtual experience or enhance a user's real-world experience in a variety of contexts and environments. For instance, extended reality systems may assist or extend a user's perception, memory, or cognition within a particular environment. Some systems may enhance a user's interactions with other people in the real world or may enable more immersive interactions with other people in a virtual world. Extended reality systems may also be used for educational purposes (e.g., for teaching or training in schools, hospitals, government organizations, military organizations, business enterprises), entertainment purposes (e.g., for playing video games, listening to music, watching video content), and/or for accessibility purposes (e.g., as hearing aids, visual aids). The embodiments disclosed herein may enable or enhance a user's extended reality experience in one or more of these contexts and environments and/or in other contexts and environments.

As noted, extended reality systems 300 and 350 may be used with a variety of other types of devices to provide a more compelling extended reality experience. These devices may be haptic interfaces with transducers that provide haptic feedback and/or that collect haptic information about a user's interaction with an environment. The extended reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

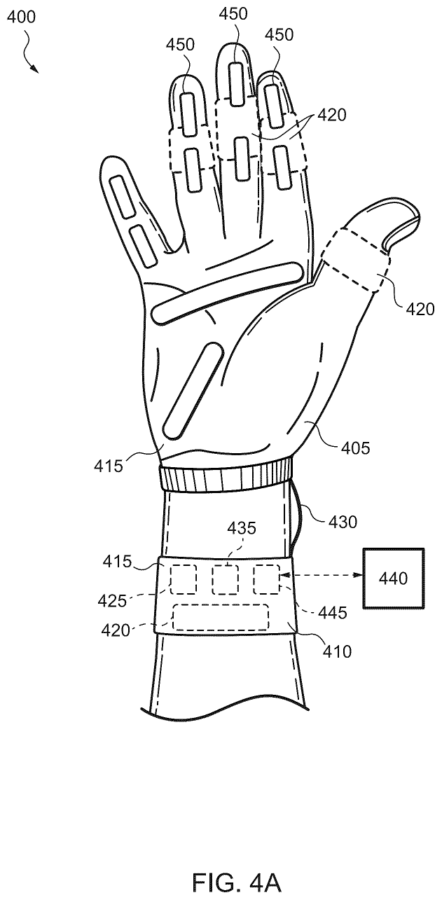

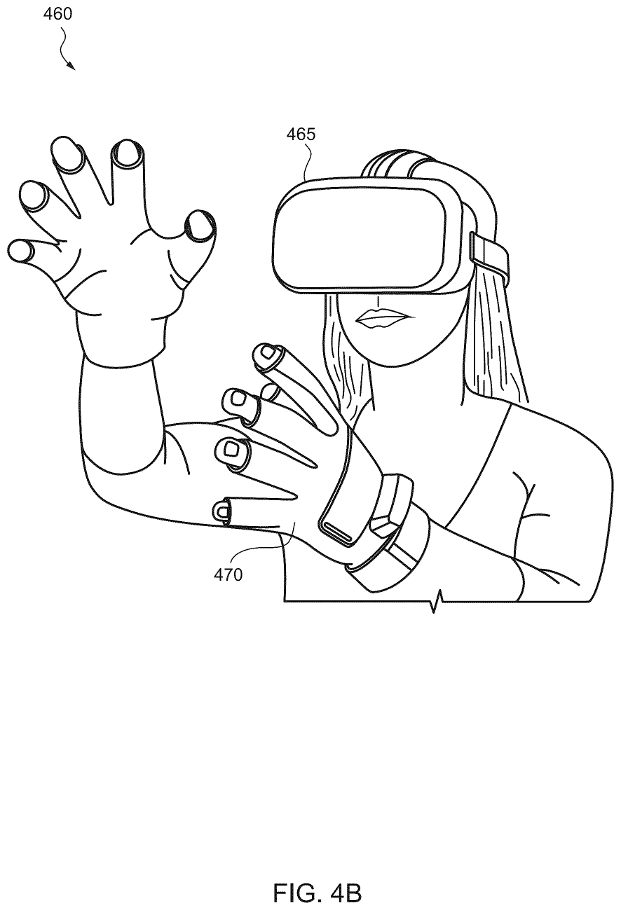

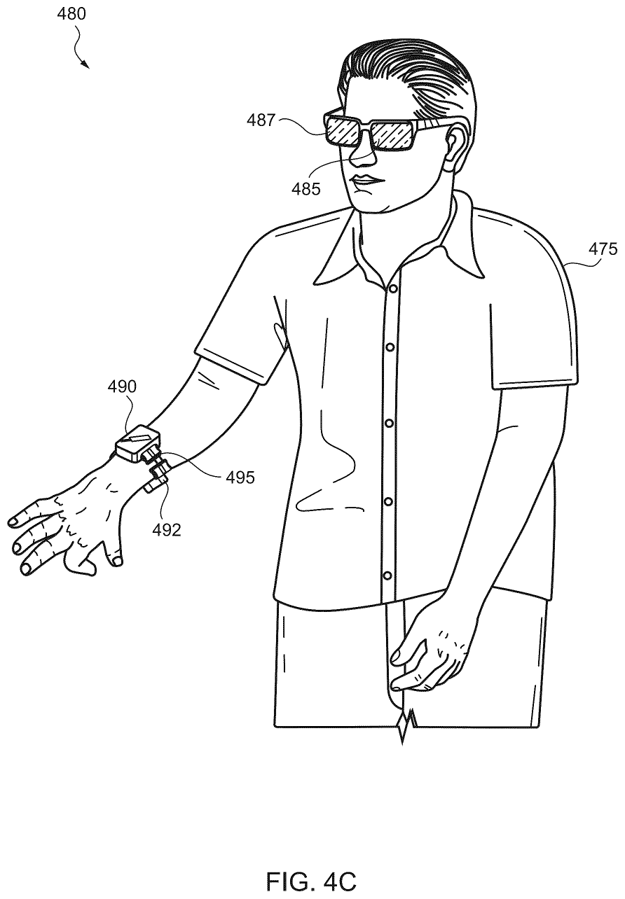

Haptic feedback may be provided by interfaces positioned within a user's environment (e.g., chairs, tables, floors) and/or interfaces on articles that may be worn or carried by a user (e.g., gloves, wristbands). As an example, FIG. 4A illustrates a vibrotactile system 400 in the form of a wearable glove (haptic device 405) and wristband (haptic device 410). Haptic device 405 and haptic device 410 are shown as examples of wearable devices that include a flexible, wearable textile material 415 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 420 may be positioned at least partially within one or more corresponding pockets formed in textile material 415 of vibrotactile system 400. Vibrotactile devices 420 may be positioned in locations to provide a vibrating sensation (e.g., haptic feedback) to a user of vibrotactile system 400. For example, vibrotactile devices 420 may be positioned against the user's finger(s), thumb, or wrist, as shown in FIG. 4A. Vibrotactile devices 420 may, in some examples, be sufficiently flexible to conform to or bend with the user's corresponding body part(s).

A power source 425 (e.g., a battery) for applying a voltage to the vibrotactile devices 420 for activation thereof may be electrically coupled to vibrotactile devices 420, such as via conductive wiring 430. In some examples, each of vibrotactile devices 420 may be independently electrically coupled to power source 425 for individual activation. In some embodiments, a processor 435 may be operatively coupled to power source 425 and configured (e.g., programmed) to control activation of vibrotactile devices 420.

Vibrotactile system 400 may be implemented in a variety of ways. In some examples, vibrotactile system 400 may be a standalone system with integral subsystems and components for operation independent of other devices and systems. As another example, vibrotactile system 400 may be configured for interaction with another device or system 440. For example, vibrotactile system 400 may, in some examples, include a communications interface 445 for receiving and/or sending signals to the other device or system 440. The other device or system 440 may be a mobile device, a gaming console, an extended reality (e.g., virtual reality, augmented reality, mixed reality) device, a personal computer, a tablet computer, a network device (e.g., a modem, a router), and a handheld controller. Communications interface 445 may enable communications between vibrotactile system 400 and the other device or system 440 via a wireless (e.g., Wi-Fi, Bluetooth, cellular, radio) link or a wired link. If present, communications interface 445 may be in communication with processor 435, such as to provide a signal to processor 435 to activate or deactivate one or more of the vibrotactile devices 420.

Vibrotactile system 400 may optionally include other subsystems and components, such as touch-sensitive pads 450, pressure sensors, motion sensors, position sensors, lighting elements, and/or user interface elements (e.g., an on/off button, a vibration control element). During use, vibrotactile devices 420 may be configured to be activated for a variety of different reasons, such as in response to the user's interaction with user interface elements, a signal from the motion or position sensors, a signal from the touch-sensitive pads 450, a signal from the pressure sensors, and a signal from the other device or system 440

Although power source 425, processor 435, and communications interface 445 are illustrated in FIG. 4A as being positioned in haptic device 410, the present disclosure is not so limited. For example, one or more of power source 425, processor 435, or communications interface 445 may be positioned within haptic device 405 or within another wearable textile.

Haptic wearables, such as those shown in and described in connection with FIG. 4A, may be implemented in a variety of types of extended reality systems and environments. FIG. 4B shows an example extended reality environment 460 including one head-mounted virtual reality display and two haptic devices (e.g., gloves), and in other embodiments any number and/or combination of these components and other components may be included in an extended reality system. For example, in some embodiments, there may be multiple head-mounted displays each having an associated haptic device, with each head-mounted display, and each haptic device communicating with the same console, portable computing device, or other computing system.

HMD 465 generally represents any type or form of virtual reality system, such as virtual reality system 350 in FIG. 3B. Haptic device 470 generally represents any type or form of wearable device, worn by a user of an extended reality system, that provides haptic feedback to the user to give the user the perception that he or she is physically engaging with a virtual object. In some embodiments, haptic device 470 may provide haptic feedback by applying vibration, motion, and/or force to the user. For example, haptic device 470 may limit or augment a user's movement. To give a specific example, haptic device 470 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 470 to send action requests to a console. Examples of action requests include, without limitation, requests to start an application and/or end the application and/or requests to perform a particular action within the application.

While haptic interfaces may be used with virtual reality systems, as shown in FIG. 4B, haptic interfaces may also be used with augmented reality systems, as shown in FIG. 4C. FIG. 4C is a perspective view of a user 475 interacting with an augmented reality system 480. In this example, user 475 may wear a pair of augmented reality glasses 485 that may have one or more displays 487 and that are paired with a haptic device 490. In this example, haptic device 490 may be a wristband that includes a plurality of band elements 492 and a tensioning mechanism 495 that connects band elements 492 to one another.

One or more of band elements 492 may include any type or form of actuator suitable for providing haptic feedback. For example, one or more of band elements 492 may be configured to provide one or more of various types of cutaneous feedback, including vibration, force, traction, texture, and/or temperature. To provide such feedback, band elements 492 may include one or more of various types of actuators. In one example, each of band elements 492 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 405, 410, 470, and 490 may include any suitable number and/or type of haptic transducer, sensor, and/or feedback mechanism. For example, haptic devices 405, 410, 470, and 490 may include one or more mechanical transducers, piezoelectric transducers, and/or fluidic transducers. Haptic devices 405, 410, 470, and 490 may also include various combinations of different types and forms of transducers that work together or independently to enhance a user's extended reality experience. In one example, each of band elements 492 of haptic device 490 may include a vibrotactor (e.g., a vibrotactile actuator) configured to vibrate in unison or independently to provide one or more various types of haptic sensations to a user.

### CAPs and Authoring of CAPs in General

Extended reality systems can assist users with performance of tasks in simulated and physical environments by providing these users with content such as information about the environments and instructions for performing the tasks. Extended reality systems can also assist users by providing content and/or performing tasks or services for users based on policies and contextual features within the environments. The rules and policies are generally created prior to the content being provided and the tasks being performed. Simulated and physical environments are often dynamic. Additionally, user preferences frequently change, and unforeseen circumstances often arise. While some extended reality systems provide users with interfaces for guiding and/or informing policies, these extended reality systems do not provide users with a means to refine polices after they have been created. As a result, the content provided and tasks performed may not always align with users' current environments or their current activities, which reduces performance and limits broader applicability of extended reality systems. The techniques disclosed herein overcome these challenges and others by providing users of extended reality systems with a means to intuitively author, i.e., create and modify, policies such as CAPs.

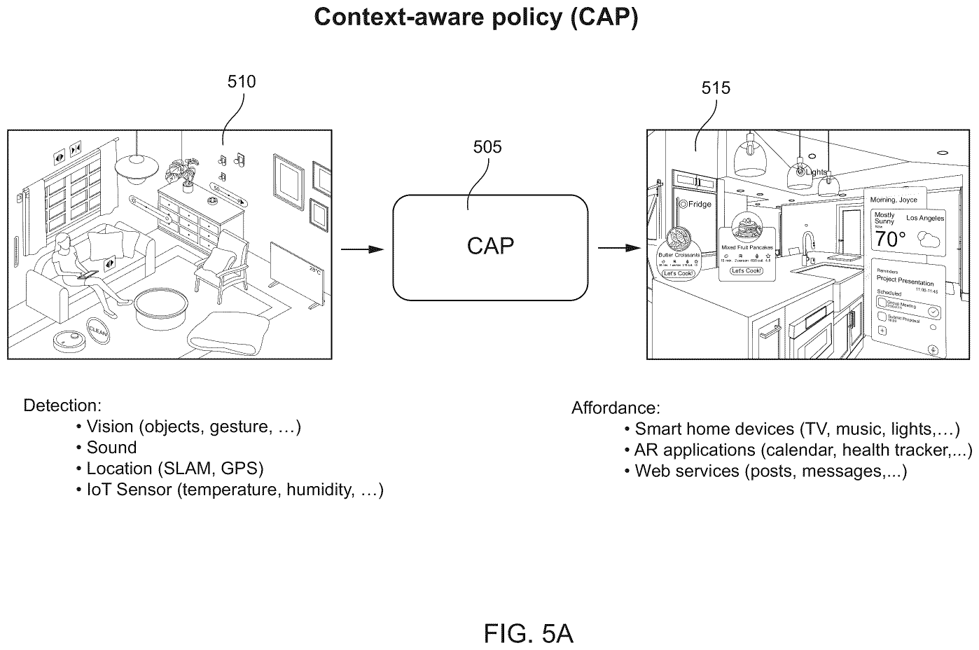

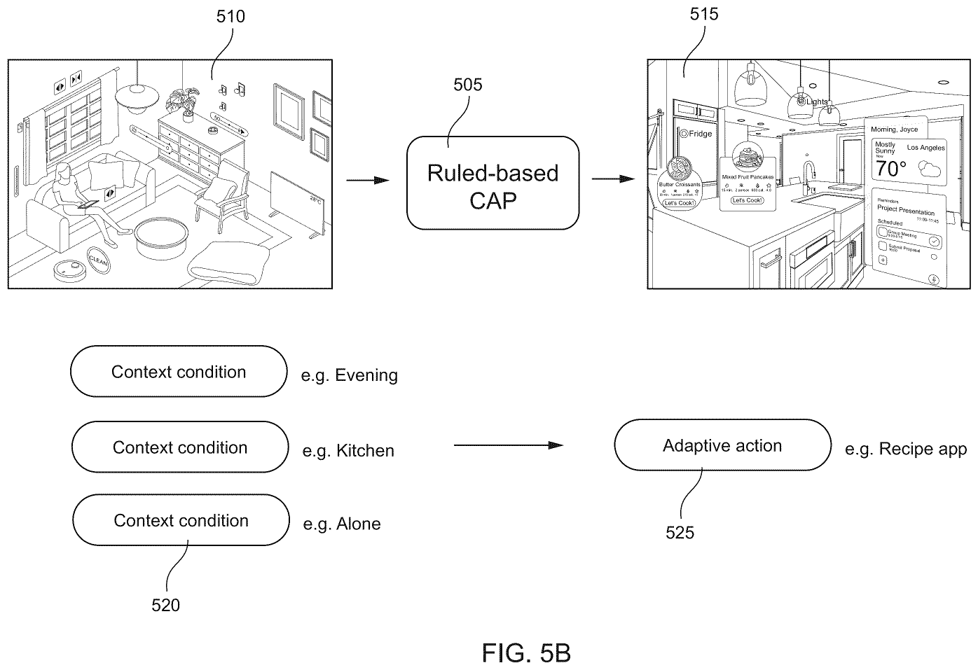

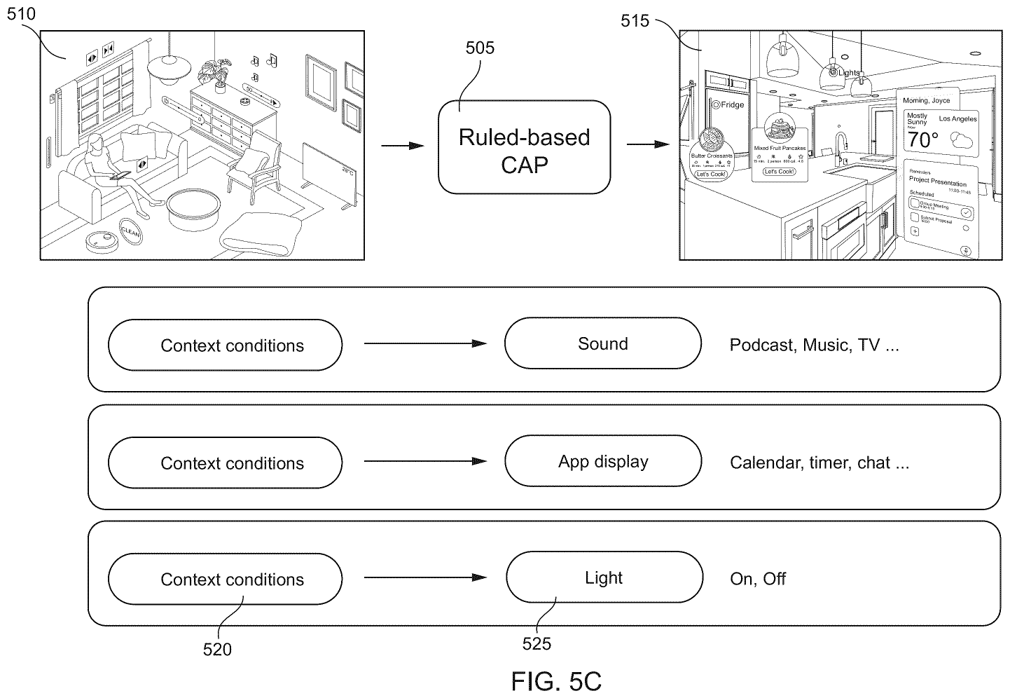

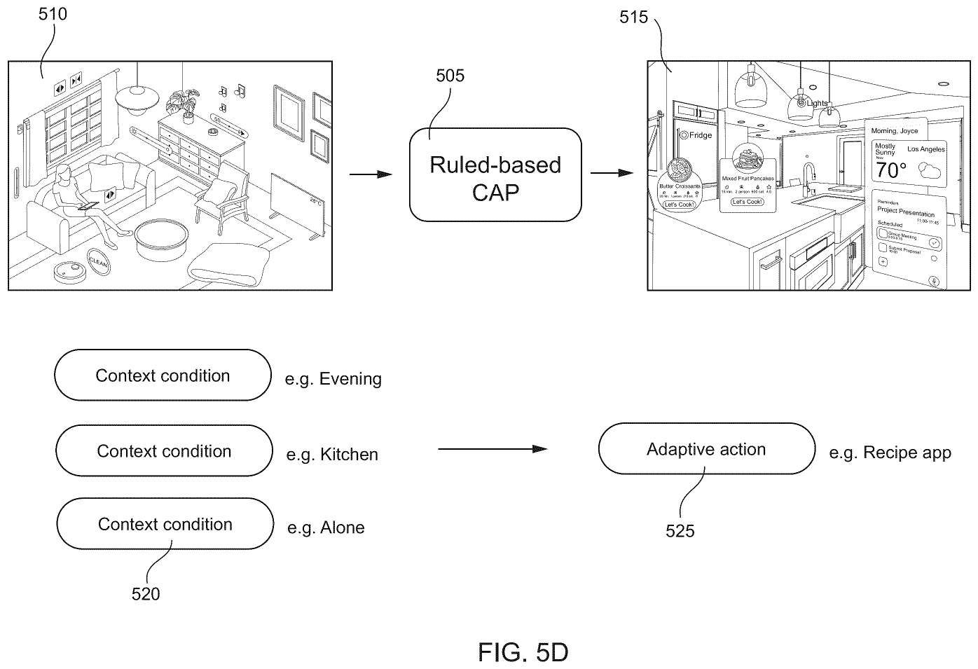

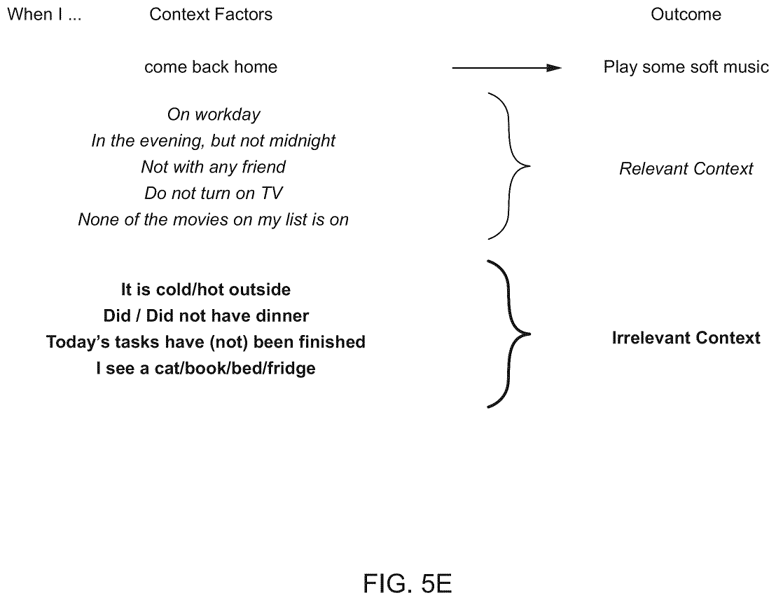

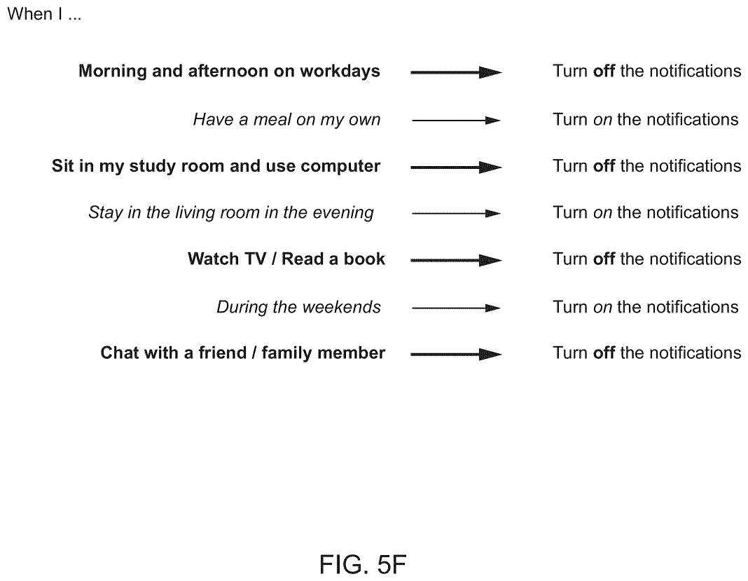

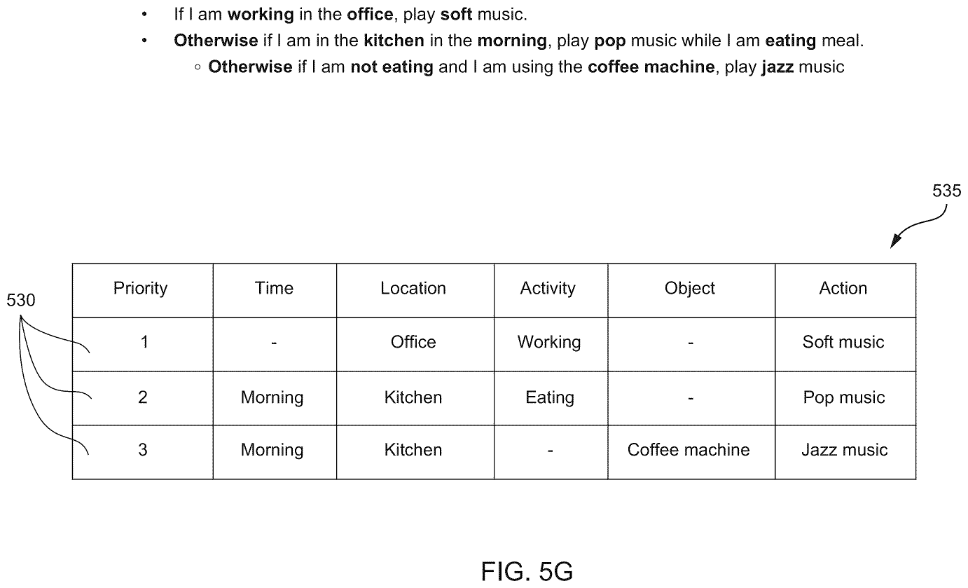

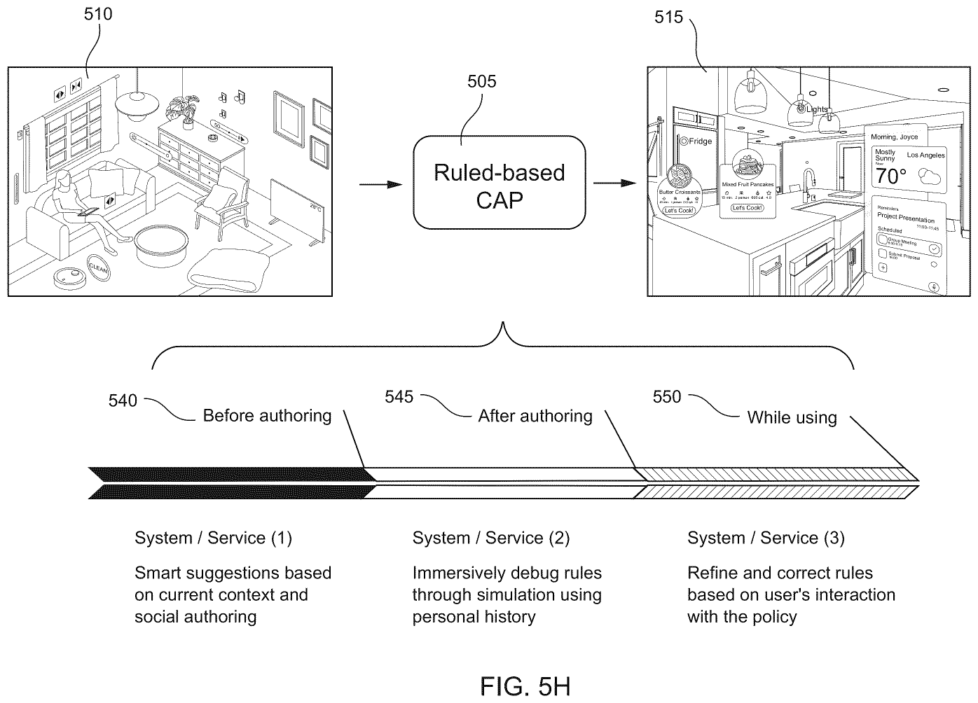

A policy such as a CAP is a core part of a contextually predictive extended reality user interface. As shown in FIG. 5A, a CAP 505 maps the context information 510 (e.g., vision, sounds, location, sensor data, etc.) detected or obtained by the client system (e.g., sensors associated with HMD that is part of client system 105 described with respect to FIG. 1) to the affordances 515 of the client system (e.g., IoT or smart home devices, extended reality applications, or web-based services associated with the client system 105 described with respect to FIG. 1). The CAP 505 is highly personalized and thus each end user should have the ability to author their own policies.

A rule-based CAP is a straightforward choice when considered in the context of end user authoring. As shown in FIG. 5B, a rule for a CAP 505 comprises one or more conditions 520 and one action 525. Once the once or more conditions 520 are met, the one action 525 is triggered. FIG. 5C shows an exemplary CAP scheme whereby each CAP 505 is configured to only control one broad action 525 at a time for affordances 515 (e.g., application display, generation of sound, control of IoT device, etc.). Each CAP 505 controls a set of actions that fall under the broader action 525 and are incompatible with each other. To control multiple things or execute multiple actions together, multiple CAPs 505 can be used. For example, a user can listen to music while checking the email and turning on a light. But the user cannot listen to music and a podcast at the same time. So, for podcast and music, one CAP 505 is configured fro the broader action 525 (sound) to control them.

The rule-based CAP is a fairly simple construct readily understood by the users, and the users can create them by selecting some conditions and actions (e.g., via an extended reality or web-based interface). However, as shown in FIGS. 5D, 5E, and 5F, it can be a challenge for users to create good rules that can cover all the relevant context accurately because there may be a lot of conditions that are involved, and the user's preference may change overtime. FIG. 5E shows some examples that demonstrate the complexity of the CAP. For example, when a user wants to create a rule of playing music when arriving back home, but the user did not realize that there are many other relevant contexts like workday, evening, not occupied with others, etc. that needed to be considered when authoring the CAP. Meanwhile there are also many irrelevant contexts like the weather that should not be considered in authoring the CAP.

FIG. 5F shows another example that demonstrates an instance where many rules may be needed for controlling one action such as a social media notification based on various relevant contexts. Some rules override others. The user usually wants to turn off the notifications during the workdays, but the user probably wants to get some social media push when they are having a meal and not meeting with others. Consequently, in some instances a CAP is authored to comprise multiple rules, and the rules may conflict with each other. As shown in FIG. 5G, in order to address these instances, the rules 530 for a CAP 505 can be placed in a priority queue or list 535. The CAP 505 can be configured such that the extended reality system first checks the rule 530 (1) in the priority queue or list 535 with the highest priority, if that rule fits the current context, the action can be triggered. If not, the extended reality system continues to refer to the rules 530 (2)-(3) in the priority queue or list 535 with lower priority. All the rules 530 together form a decision tree that can handle the complex situations. Meanwhile, any single rule can be added, deleted or changed without influencing others significantly. To author such a CAP 505, the user needs to figure out what rules should be include in the CAP 505, then, the user should maintain the accuracy of the CAP 505 by adjusting the conditions in some rules and adjust the priority of the rules.

As shown in FIG. 5H, multiple efforts have been developed to assist users to create CAPs. Before the users start authoring, the virtual assistant uses an artificial intelligence-based subsystem/service 540 that provides gives users suggestions about the rules they can author based on a current context. Thereafter, another artificial intelligence-based subsystem/service 545 simulates different context so that users can debug their CAPs immersively. Based on user's interaction, another artificial intelligence-based subsystem/service 550 gives users hints and suggestions to update and refine the CAP. Advantageously, this allows the users create and maintain the CAP model without creating new rules from scratch or paying attention to the complex multi-context/multi-rule CAP.

### System for Executing and Authoring CAPs

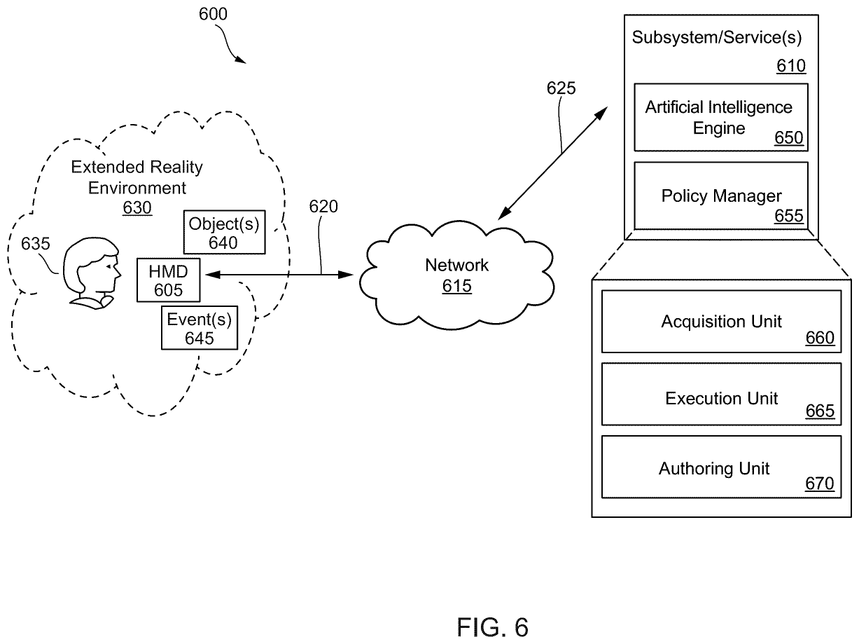

FIG. 6 is a simplified block diagram of a policy authoring and execution system 600 for authoring policies in accordance with various embodiments. The policy authoring and execution system 600 includes an HMD 605 (e.g., an HMD that is part of client system 105 described with respect to FIG. 1) and one or more extended reality subsystems/services 610 (e.g., a subsystem or service that is part of client system 105, virtual assistant engine 110, and/or remote systems 115 described with respect to FIG. 1). The HMD 605 and subsystems/services 610 are in communication with each via a network 615. The network 615 can be any kind of wired or wireless network that can facilitate communication among components of the policy authoring and execution system 600, as described in detail herein with respect to FIG. 1. For example, the network 615 can facilitate communication between and among the HMD 605 and the subsystems/services 610 using communication links such as communication channels 620, 625. The network 615 can include one or more public networks, one or more private networks, or any combination thereof. For example, the network 615 can be a local area network, a wide area network, the Internet, a Wi-Fi network, a Bluetooth® network, and the like.

The HMD 605 is configured to be operable in an extended reality environment 630 (“environment 630”). The environment 630 can include a user 635 wearing HMD 605, one or more objects 640, and one or more events 645 that can exist and/or occur in the environment 630. The user 635 wearing the HMD 605 can perform one or more activities in the environment 630 such as performing a sequence of actions, interacting with the one or more objects 640, interacting with, initiating, or reacting to the one or more events 645 in the environment 630, interacting with one or more other users, and the like.

The HMD 605 is configured to acquire information about the user 635, one or more objects 640, one or more events 645, and environment 630 and send the information through the communication channel 620, 625 to the subsystems/services 610. In response, the subsystems/services 610 can generate a virtual environment and send the virtual environment to the HMD 605 through the communication channel 620, 625. The HMD 605 is configured to present the virtual environment to the user 635 using one or more displays and/or interfaces of the HMD 605. Content and information associated with the virtual environment can be presented to the user 635 as part of the environment 630. Examples of content include audio, images, video, graphics, Internet-based content (e.g., webpages and application data), user interfaces, and the like.

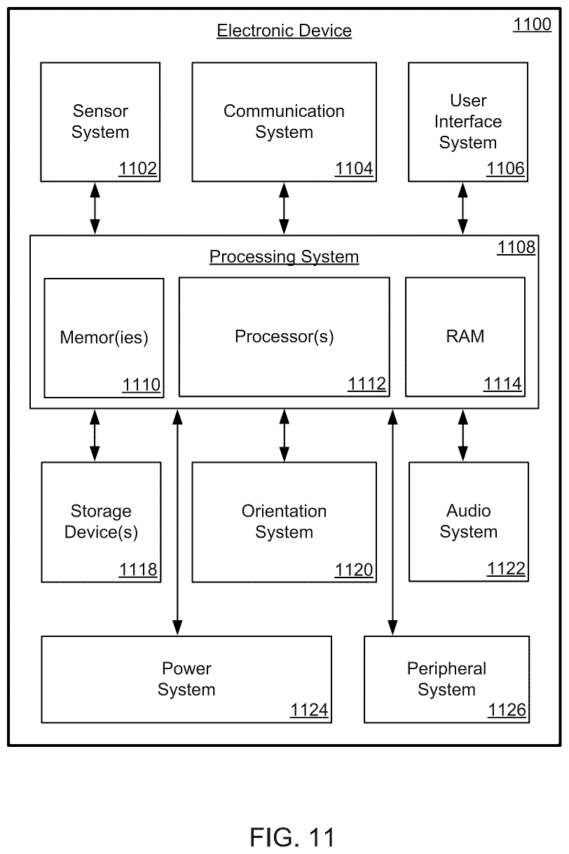

The HMD 605 is configured with hardware and software to provide an interface that enables the user 635 to view and interact with the content within the environment 630 and author CAPs using a part of or all the techniques disclosed herein. In some embodiments, the HMD 605 can be implemented as the HMD described above with respect to FIG. 2A. Additionally, or alternatively, the HMD 605 can be implemented as an electronic device such as the electronic device 1100 shown in FIG. 11. The foregoing is not intended to be limiting and the HMD 605 can be implemented as any kind of electronic or computing device that can be configured to provide access to one or more interfaces for enabling users to view and interact with the content within environment 630 and author policies using a part of or all the techniques disclosed herein.

The subsystems/services 610 includes an artificial intelligence engine 650 and a policy manager 655. The subsystems/services 610 can include one or more special-purpose or general-purpose processors. Such special-purpose processors can include processors that are specifically designed to perform the functions of the artificial intelligence engine 650 and the policy manager 655. Additionally, the artificial intelligence engine 650 and the policy manager 655 can include one or more special-purpose or general-purpose processors that are specifically designed to perform the functions of those units. Such special-purpose processors may be application-specific integrated circuits (ASICs), field-programmable gate arrays (FPGAs), programmable logic devices (PLDs), and graphic processing units (GPUs), which are general-purpose components that are physically and electrically configured to perform the functions detailed herein. Such general-purpose processors can execute special-purpose software that is stored using one or more non-transitory processor-readable mediums, such as random-access memory (RAM), flash memory, a hard disk drive (HDD), or a solid-state drive (SSD). Further, the functions of the artificial intelligence engine 650 and the policy manager 655 can be implemented using a cloud-computing platform, which is operated by a separate cloud-service provider that executes code and provides storage for clients.

The artificial intelligence engine 650 is configured to receive information about the user 635, one or more objects 640, one or more events 645, environment 630, IoT or smart home devices, and remote systems from the HMD 605 and provide inferences (e.g., object detection or context prediction) concerning the user 635, one or more objects 640, one or more events 645, environment 630, IoT or smart home devices, and remote systems to the HMD 605, the policy manager 655, or another application for the generation and presentation of content to the user 635. In some embodiments, the content can be the extended reality content 225 described above with respect to FIG. 2A. Other examples of content include audio, images, video, graphics, Internet-based content (e.g., webpages and application data), and the like. The subsystems/services 610 is configured to provide an interface (e.g., a graphical user interface) that enables the user 635 to use the HMD 605 to view and interact with the content and within the environment 630 and in some instances author policies using a part of or all the techniques disclosed herein based on the content.

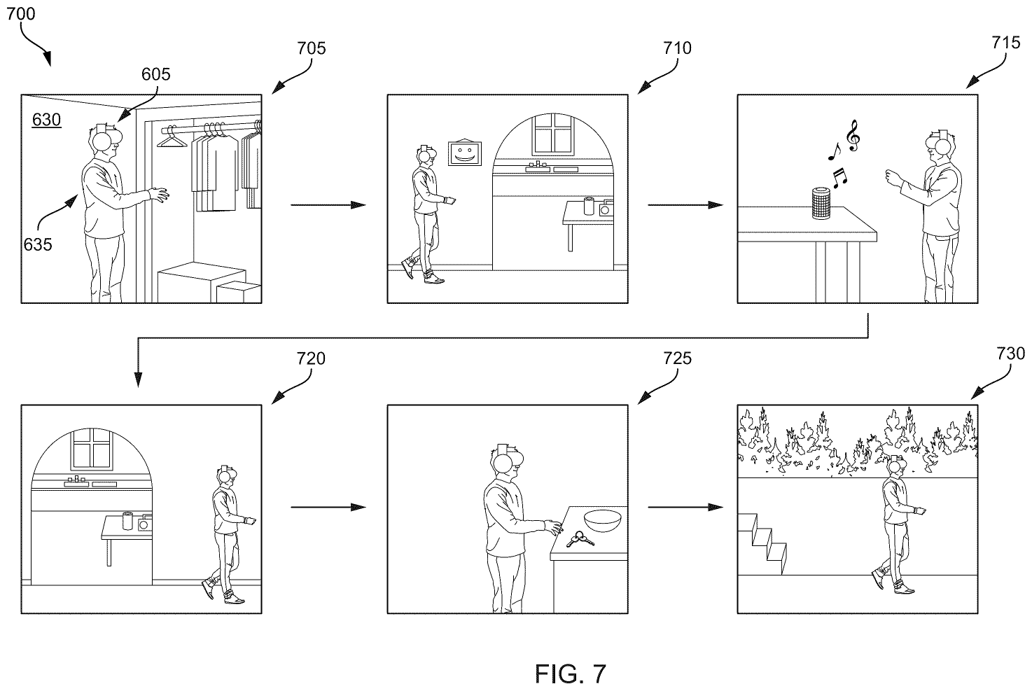

Policy manager 655 includes an acquisition unit 660, an execution unit 665, and an authoring unit 670. The acquisition unit 660 is configured to acquire context concerning an event 645 or activity within the environment 630. The context is the circumstances that form the setting for an event or activity (e.g., what is the time of day, who is present, what is the location of the event/activity, etc.). An event 645 generally includes anything that takes place or happens within the environment 630. An activity generally includes the user 635 performing an action or sequence of actions in the environment 630 while wearing HMD 605. For example, the user 635 walking along a path while wearing HMD 605. An activity can also generally include the user 635 performing an action or sequence of actions with respect to the one or more objects 640, the one or more events 645, and other users in the environments 530 while wearing HMD 605. For example, the user 635 standing from being seated in a chair and walking into another room while wearing HMD 605. An activity can also include the user 635 interacting with the one or more objects 640, the one or more events 645, other users in the environment 630 while wearing HMD 605. For example, the user 635 organizing books on shelf and talking to a nearby friend while wearing HMD 605. FIG. 7 illustrates an exemplary scenario of a user performing an activity in an environment. As shown in FIG. 7, a user 635 in environment 630 can start a sequence of actions in their bedroom by waking up, putting on HMD 605, and turning on the lights. The user 635 can then, at scene 705, pick out clothes from their closet and get dressed. The user 635 can then, at scenes 710 and 715, walk from their bedroom to the kitchen and turn on the lights and a media playback device (e.g., a stereo receiver, a smart speaker, a television) in the kitchen. The user 635 can then, at scenes 720, 725, and 730, walk from the kitchen to the entrance of their house, pick up their car keys, and leave their house. The context of these events 645 and activities acquired by the acquisition unit 660 may include bedroom, morning, lights, clothes, closet in bedroom, waking up, kitchen, lights, media player, car keys, leaving house, etc.

To recognize and acquire context for an event or activity, the acquisition unit 660 is configured to collect data from HMD 605 while the user is wearing HMD 605. The data can represent characteristics of the environment 630, user 635, one or more objects 640, one or more events 645, and other users. In some embodiments, the data can be collected using one or more sensors of HMD 605 such as the one or more sensors 215 as described with respect to FIG. 2A. For example, the one or more sensors 215 can capture images, video, and/or audio of the user 635, one or more objects 640, and one or more events 645 in the environment 630 and send image, video, and/or audio information corresponding to the images, video, and audio through the communication channel 620, 625 to the subsystems/services 610. The acquisition unit 660 can be configured to receive the image, video, and audio information and can format the information into one or more formats suitable for suitable for image recognition processing, video recognition processing, audio recognition processing, and the like.

The acquisition unit 660 can be configured to start collecting the data from HMD 605 when HMD 605 is powered on and when the user 635 puts HMD 605 on and stop collecting the data from HMD 605 when either HMD 605 is powered off or the user 635 takes HMD 605 off. For example, at the start of an activity, the user 635 can power on or put on HMD 605 and, at the end of an activity, the user 635 can power down or take off HMD 605. The acquisition unit 660 can also be configured to start collecting the data from HMD 605 and stop collecting the data from HMD 605 in response to one or more natural language statements, gazes, and/or gestures made by the user 635 while wearing HMD 605. In some embodiments, the acquisition unit 660 can monitor HMD 605 for one or more natural language statements, gazes, and/or gestures made by the user 635 while the user 635 is interacting within environment 630 that reflect a user's desire for data to be collected (e.g., when a new activity is being learned or recognized) and/or for data to stop being collected (e.g., after an activity has been or recognized). For example, while the user 635 is interacting within environment 630, the user 635 can utter the phrase “I'm going to start my morning weekday routine” and “My morning weekday routine has been demonstrated” and HMD 605 can respectively start and/or stop the collecting the data in response thereto.

In some embodiments, the acquisition unit 660 is configured to determine whether the user 635 has permitted the acquisition unit 660 to collect data. For example, the acquisition unit 660 can be configured to present a data collection authorization message to the user 635 on HMD 605 and request the user's 635 permission for the acquisition unit 660 to collect the data. The data collection authorization message can serve to inform the user 635 of what types or kinds of data that can be collected, how and when that data will be collected, and how that data will be used by the policy authoring and execution system and/or third parties. In some embodiments, the user 635 can authorize data collection and/or deny data collection authorization using one or more natural language statements, gazes, and/or gestures made by the user 635. In some embodiments, the acquisition unit 660 can request the user's 635 authorization on a periodic basis (e.g., once a month, whenever software is updated, and the like).

The acquisition unit 660 is further configured to use the collected data to recognize an event 645 or activity performed by the user 635. To recognize an event or activity, the acquisition unit 660 is configured to recognize characteristics of the activity. The characteristics of the activity include but are not limited to: i. the actions or sequences of actions performed by the user 635 in the environment 630 while performing the activity; ii. the actions or sequences of actions performed by the user 635 with respect to the one or more objects 640, the one or more events 645, and other users in the environment 630 while performing the activity; and iii. the interactions between the user 635 and the one or more objects 640, the one or more events 645, and other users in the environment 630 while performing the activity. The characteristics of the activity can also include context of the activity such as times and/or time frames and a location and/or locations in which the activity was performed by the user 635.

In some embodiments, the acquisition unit 660 can be configured to recognize and acquire the characteristics or context of the activity using one or more recognition algorithms such as image recognition algorithms, video recognition algorithms, semantic segmentation algorithms, instance segmentation algorithms, human activity recognition algorithms, audio recognition algorithms, speech recognition algorithms, event recognition algorithms, and the like. Additionally, or alternatively, the acquisition unit 660 can be configured to recognize and acquire the characteristics or context of the activity using one or more machine learning models (e.g., neural networks, generative networks, discriminative networks, transformer networks, and the like) via the artificial intelligence engine 650. The one or more machine learning models may be trained to detect and recognize characteristics or context. In some embodiments, the one or more machine learning models include one or more pre-trained models such as models in the GluonCV and GluonNLP toolkits. In some embodiments, the one or more machine learning models can be trained based on unlabeled and/or labeled training data. For example, the training data can include data representing characteristics or context of previously recognized activities, the data used to recognize those activities, and labels identifying those characteristics or context. The one or more machine learning models can be trained and/or fine-tuned using one or more training and fine-tuning techniques such as unsupervised learning, semi-supervised learning, supervised learning, reinforcement learning, and the like. In some embodiments, training and fine-tuning the one or more machine learning models can include optimizing the one or more machine learning models using one or more optimization techniques such as backpropagation, Adam optimization, and the like. The foregoing implementations are not intended to be limiting and other arrangements are possible.

The acquisition unit 660 may be further configured to generate and store data structures for characteristics, context, events, and activities that have been acquired and/or recognized. The acquisition unit 660 can be configured to generate and store a data structure for the characteristics, context, events, and activities that have been acquired and/or recognized. A data structure for a characteristic, context, event, or activity can include an identifier that identifies the characteristic, context, event, or activity and information about the characteristic, context, event, or activity. In some embodiments, the data structure can be stored in a data store (not shown) of the subsystems/services 610. In some embodiments, the data structure can be organized in the data store by identifiers of the data structures stored in the data store. For example, the identifiers for the data structures stored in the data store can be included in a look-up table, which can point to the various locations where the data structures are stored in the data store. In this way, upon selection of an identifier in the look-up table, the data structure corresponding to the identifier can be retrieved, and the information stored in the activity data structure can be used for further processing such as for policy authoring and execution as described below.

The execution unit 665 is configured to execute policies based on the data acquired by the acquisition unit 660. The execution unit 665 may be configured to start executing policies when HMD 605 is powered on and when the user 635 puts HMD 605 on and stop executing policies when either HMD 605 is powered off or the user 635 takes HMD 605 off. For example, at the start of an activity or the day, the user 635 can power on or put on HMD 605 and, at the end of an activity or day, the user 635 can power down or take off HMD 605. The execution unit 665 can also be configured to start and stop executing policies in response to one or more natural language statements, gazes, and/or gestures made by the user 635 while wearing HMD 605. In some embodiments, the execution unit 665 can monitor HMD 605 for one or more natural language statements, gazes, and/or gestures made by the user 635 while the user 635 is interacting within environment 630 that reflect user's desire for the HMD 605 to start and stop executing policies (e.g., the user 635 performs a gesture that indicates the user's desire for HMD 605 to start executing policies and subsequent gesture at a later time that indicates the user's desire for HMD 605 to stop executing policies) and/or for a policy to stop being executed (e.g., the user 635 performs another gesture that indicates that the user 635 has just finished a routine).

The execution unit 665 is configured to execute policies by determining whether the current characteristics or context acquired by the acquisition unit 660 satisfies or match the one or more conditions of a policy or rule. For example, the execution unit 665 is configured to determine whether the current characteristics or context of activity performed by the user 635 in the environment 630 satisfy/match the one or more conditions of a CAP. In another example, the execution unit 665 is configured to determine whether the current characteristics or context of activity performed by the user 635 with respect to the one or more objects 640, the one or more events 645, and other users in the environment 630 satisfy/match the one or more conditions of a CAP. The satisfaction or match can be a complete satisfaction or match or a substantially complete satisfaction or match. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

Once it is determined that the characteristics or context acquired by the acquisition unit 660 satisfy or match the one or more conditions of a policy or rule, the execution unit 665 is further configured to cause the client system (e.g., virtual assistant) to execute one or more actions for the policy or rule in which one or more conditions have been satisfied or matched. For example, the execution unit 665 is configured to determine that one or more conditions of a policy have been satisfied or matched by characteristics acquired by the acquisition unit 660 and cause the client system to perform one or more actions of the policy. The execution unit 665 is configured to cause the client system to execute the one or more actions by communicating the one or more actions for execution to the client system. For example, the execution unit 665 can be configured to cause the client system to provide content to the user 635 using a display screen and/or one or more sensory devices of the HMD 605. In another example, and continuing with the exemplary scenario of FIG. 7, the execution unit 665 can determine that the user 635 has satisfied a condition of a CAP by entering and turning on the lights in the kitchen and causes the client system to provide an automation such as causing the HMD 605 to display a breakfast recipe to the user 635.

The authoring unit 670 is configured to allow for the authoring of policies or rules such as CAPs. The authoring unit 670 is configured to author policies by facilitating the creation of policies (e.g., via an extend reality or web-based interface), simulation of policy performance, evaluation of policy performance, and refinement of policies based on simulation and/or evaluation of policy performance. To evaluate policy performance, the authoring unit 670 is configured to collect feedback from the user 635 for policies executed by the execution unit 665 or simulated by the authoring unit 670. The feedback can be collected passively, actively, and/or a combination thereof. In some embodiments, the feedback can represent that the user 635 agrees with the automation and/or is otherwise satisfied with the policy (i.e., a true positive state). The feedback can also represent that the user 635 disagrees with the automation and/or is otherwise dissatisfied with the policy (i.e., a false positive state). The feedback can also represent that the automation is opposite of the user's 635 desire (i.e., a true negative state). The feedback can also represent that the user 635 agrees that an automation should not be performed (i.e., a false negative state).

The authoring unit 670 is configured to passively collect feedback by monitoring the user's 635 reaction or reactions to performance and/or non-performance of an automation of the policy by the client system during execution of the policy. For example, and continuing with the exemplary scenario of FIG. 7, the execution unit 665 can cause the HMD 605 to display a breakfast recipe to the user 635 in response to determining that the user 635 has entered and turned on the lights in the kitchen. In response, the user 635 can express dissatisfaction with the automation by canceling the display of the breakfast recipe, giving a negative facial expression when the breakfast recipe is displayed, and the like. In another example, the user 635 can express satisfaction with the automation by leaving the recipe displayed, uttering the phase “I like the recipe,” and the like.

The authoring unit 670 is configured to actively collect feedback by requesting feedback from the user 635 while a policy is executing, or the execution is being simulated. The authoring unit 670 is configured to request feedback from the user 635 by generating a feedback user interface and presenting the feedback user interface on a display of HMD 605. In some embodiments, the feedback user interface can include a textual and/or visual description of the policy and one or more automations of the policy that have been performed by the client system and a set of selectable icons. In some embodiments, the set of selectable icons can include an icon which when selected by the user 635 represents that the user 635 agrees with the one or more automations of the policy (e.g., an icon depicting a face having a smiling facial expression), an icon which when selected by the user 635 represents that the user 635 neither agrees nor disagrees (i.e., neutral) with the one or more automations of the policy (e.g., an icon depicting a face having a neutral facial expression), and an icon which when selected by the user 635 represents that the user 635 disagrees with the one or more automations (e.g., an icon depicting a face having a negative facial expression). Upon presenting the feedback user interface on the display of the HMD 605, the authoring unit 670 can be configured to determine whether the user 635 has selected an icon by determining whether the user 635 has made one or more natural language utterances, gazes, and/or gestures that indicate the user's 635 sentiment towards one particular icon. For example, upon viewing the feedback user interface, the user 635 can perform a thumbs up gesture and the authoring unit 670 can determine that the user 635 has selected the icon which represents the user's 635 agreement with the one or more automations of the policy. In another example, upon viewing the feedback user interface, the user 635 may utter a phrase “ugh” and the authoring unit 670 can determine that the user 635 has selected the icon which represents that the user 635 neither agrees nor disagrees with the one or more automations.

The authoring unit 670 is configured to determine context (also referred to herein as context factors) associated with the feedback while the authoring unit 670 is collecting feedback from the user 635. A context factor, as used herein, generally refers to conditions and characteristics of the environment 630 and/or one or more objects 640, the one or more events 645, and other users that exist and/or occur in the environment 630 while a policy is executing. A context factor can also refer to a time and/or times frames and a location or locations in which the feedback is being collected from the user 635. For example, the context factors can include a time frame during which feedback was collected for a policy, a location where the user 635 was located when the feedback was collected, an indication of the automation performed, an indication of the user's 635 feedback, and an indication of whether the user's 635 feedback reflects an agreement and/or disagreement with the automation.

The authoring unit 670 is configured to generate a feedback table in a data store (not shown) of the subsystems/services 610 for policies executed or simulated by the execution unit 665 or authoring unit 670. The feedback table stored the context evaluated for execution or simulation of the policy, the action triggered by the execution or simulation of the policy, and the feedback provided by the user in reaction to the action triggered by the execution or simulation of the policy. More specifically, the feedback table can be generated to include rows representing instances when the policy was executed and columns representing the context, actions, and the feedback for each execution instance. For example, and continuing with the exemplary scenario of FIG. 7, for a policy that causes the HMD 605 to display information regarding the weather for the day to the user 635, the authoring unit 670 can store, for an execution instance of the policy, context that include a time frame between 8-10 AM or morning and a location that is the user's home or bedroom, an indication that the policy caused the HMD 605 to perform the action —display weather information, and feedback comprising an indication that the user 635 selected an icon representative of the user's agreement with the automation (e.g., an icon depicting a face having a smiling facial expression).

The authoring unit 670 is configured to evaluate performance of a policy based on the information (i.e., context, action, and feedback) in the feedback table. In some instances, the authoring unit 670 is configured to evaluate performance of a policy using an association rule learning algorithm. To evaluate performance of a policy, the authoring unit 670 is configured to calculate and compare the performance of a policy using the metrics of support and confidence. Support is the subset of the dataset within the feedback table where that the policy has been correct ((conditions->Action)=N(Factors, Action). The frequency that the rule has been correct. The confidence is the certainty that the context will lead to the correct action ((conditions->Action)=N(Factors, Action)/N(Factors)). To calculate the confidence, the authoring unit 670 is configured to: i. determine a number of execution instances of the policy; ii. determine a number of execution instances for the policy in which the context factors of the respective execution instances match the context factors of the execution instances of the policy included in the support set; iii. divide the first number i by the second number ii; and iv. express the results of the division as a percentage.

The authoring unit 670 is configured to determine that a policy is eligible for refinement when the confidence for the existing policy is below a predetermined confidence threshold. In some embodiments, the predetermined confidence threshold is any value between 50% and 100%. The authoring unit 670 is configured to refine the policy when the authoring unit 670 determines that the policy is eligible for refinement. A policy refinement, as used herein, refers to a modification of at least one condition or action of the policy.

To refine a policy, the authoring unit 670 is configured to generate a set of replacement policies for the policy and determine which replacement policy included in the set of replacement policies can serve as a candidate replacement policy for replacing the policy that is eligible for replacement. The authoring unit 670 is configured to generate a set of replacement policies for the policy by applying a set of policy refinements to the existing policy. The authoring unit 670 is configured to apply a set of policy refinements to the existing policy by selecting a refinement from a set of refinements and modifying the existing policy according to the selected refinement. The set of refinements can include but is not limited to changing an automation, changing a condition, changing an arrangement of conditions (e.g., first condition and second condition to first condition or second condition), adding a condition, and removing a condition. For example, for a policy that causes the client system to turn on the lights when the user 635 is at home at 12 PM (i.e., noon), the authoring unit 670 can generate a replacement policy that modifies the existing policy to cause the client system to turn off the lights rather than turn them on. In another example, for the same policy, the authoring unit 670 can generate a replacement policy that modifies the existing policy to cause the client system to turn on the lights when the user 635 is at home at night rather than at noon, turn on the lights when the user 635 is home at night or at noon, or turn on the lights when the user 635 is at home, in the kitchen, at noon, turn on the lights when the user 635 is simply at home, and the like. In a further example, for the same policy, the authoring unit 670 can generate a replacement policy that causes the client system to turn off the lights and a media playback device when the user 635 is not at home in the morning. In some embodiments, rather than applying a policy refinement to the existing policy, the authoring unit 670 can be configured to generate a new replacement policy and add the generated new replacement policy to the set of replacement policies. In some embodiments, at least one characteristic of the generated new replacement policy (e.g., a condition or automation) is the same as at least one characteristic of the existing policy. In some embodiments, rather than generating a set of replacement policies for the existing policy and determining which replacement policy of the set of replacement policies should replace the existing policy, the authoring unit 670 can be configured to remove and/or otherwise disable the policy (e.g., by deleting, erasing, overwriting, etc., the policy data structure for the policy stored in the data store).

The authoring unit 670 is configured to determine which replacement policy included in the set of replacement policies for an existing policy can serve as a candidate replacement policy for replacing the existing policy. The authoring unit 670 is configured to determine the candidate replacement policy by extracting a replacement support for each replacement policy included in the set of replacement policies from the feedback table for the existing policy and calculating a replacement confidence for each replacement support. The authoring unit 670 is configured to extract a replacement support for a replacement policy by identifying rows of the feedback table for the existing policy in which the user's 635 feedback indicates an agreement with an automation included in the replacement policy and extracting the context factors for each row that is identified. In some embodiments, the authoring unit 670 is configured to prune the replacement support for the replacement policy by comparing the replacement support to the extracted support for the existing policy (see discussion above) and removing any execution instances included in the replacement support that are not included in the support for the existing policy. To calculate a replacement confidence for a replacement support, the authoring unit 670 is configured to: i. determine a number of execution instances of the existing policy included in the respective replacement support (i.e., a first number); ii. determine a number of execution instances of the existing policy in which the context of the respective execution instances match the context of the execution instances of the policy included in the replacement support (i.e., a second number); iii. divide the first number by the second number; and iv. express the results of the division as a percentage. The authoring unit 670 is configured to determine that a replacement policy included in the set of replacement policies can serve as a candidate replacement policy if the replacement confidence for the respective replacement policy is greater than the confidence for the existing policy (see discussion above).

The authoring unit 670 is configured to determine a candidate replacement policy for each policy executed by the execution unit 528 and present the candidate replacement policies to the user 635. The authoring unit 670 is configured to present candidate replacement policies to the user 635 by generating a refinement user interface and presenting the refinement user interface on a display of HMD 605. In some embodiments, the refinement user interface can include a textual and/or visual description of the candidate replacement policies and an option to manually refine the policies. For example, for a policy that causes the extended reality system 500 to turn on the lights when the user 635 is at home at 12 PM (i.e., noon), the authoring unit 670 can determine a replacement policy that causes the client system to turn off the lights under the same conditions to be a suitable candidate replacement policy and can present the candidate replacement policy to the user 635 in a refinement user interface 700 using a textual and visual description 702 of the candidate replacement policy and an option 704 to manually refine the candidate replacement policy. Upon presenting the refinement user interface on the display of the HMD 605, the authoring unit 670 can be configured to determine whether the user 635 has accepted or approved the candidate replacement policy or indicated a desire manually refine the policy. For example, the authoring unit 670 can be configured to determine whether the user 635 has made one or more natural language utterances, gazes, and/or gestures that are indicative of the user sentiment towards candidate replacement policy and/or the option to manually refine the policy. In some embodiments, upon selecting the manual refinement option, the authoring unit 670 can be configured to generate a manual refinement user interface for manually refining the policy. The manual refinement user interface can include one or more selectable buttons representing options for manually refining the policy. In some embodiments, the authoring unit 670 can be configured to provide suggestions for refining the policy. In this case, the authoring unit 670 can derive the suggestions from characteristics of the replacement policies in the set of replacement policies for the existing policy. For example, a manual refinement user interface 706 can include a set of selectable buttons that represent options for modifying the policy and one or more suggestions for refining the candidate replacement policy. In some embodiments, the authoring unit 670 can be configured to present the refinement user interface on the display of the HMD 605 for a policy when the policy fails (e.g., by failing to detect the satisfaction of a condition and/or by failing to perform an automation). In other embodiments, the authoring unit 670 can be configured to present the refinement user interface on the display of the HMD 605 whenever a candidate replacement policy is determined for the existing policy. In some embodiments, rather than obtaining input from the user 635, the authoring unit 670 can be configured to automatically generate a replacement policy for an existing policy without input from the user 635.

The authoring unit 670 is configured to replace the existing policy with the candidate replacement policy approved, manually refined, and/or otherwise accepted by the user 635. The authoring unit 670 is configured to replace the existing policy by replacing the policy data structure for the existing policy stored in the data store with a replacement policy data structure for the replacement policy. In some embodiments, when a policy has been replaced, the authoring unit 670 is configured to discard the feedback table for the policy and store collected feedback for the replacement policy in a feedback table for the replacement policy. In this way, policies can continuously be refined based on collected feedback.

Using the techniques described herein, policies can be modified in real-time based on the users' experiences in dynamically changing environments. Rules and policies under which extended reality systems provide content and assist users with performing tasks are generally created prior to the content being provided and the tasks being performed. As such, the content provided and tasks performed do not always align with users' current environments and activities, which reduces performance and limits broader applicability of extended reality systems. Using the policy refinement techniques described herein, these challenges and others can be overcome.

### CAP Authoring Architecture (Defining and Modifying Using Natural Language and Demonstrations)

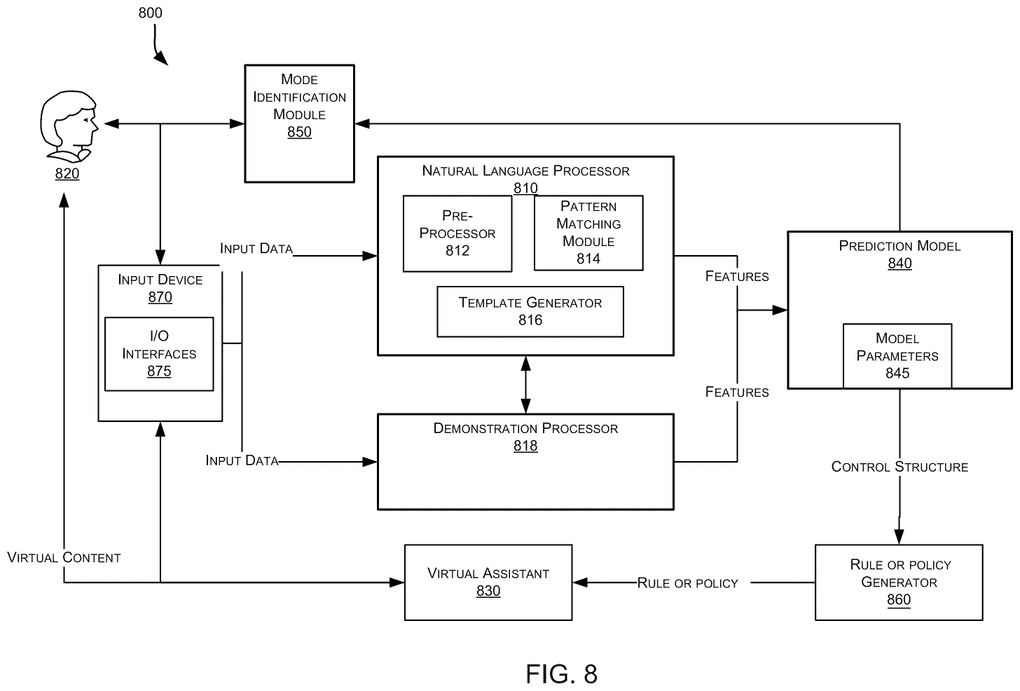

FIG. 8 illustrates an example architecture 800 associated with an extended reality system in accordance with aspects of the present disclosure. In particular, the architecture 800 provides a combination of elements for creating, modifying, or deleting rules and policies that define the behavior of and make up the basis for different operations carried out by a virtual assistant 830. The architecture 800 provides the elements necessary to enable a user 820 to create, modify, or delete one or more rules or policies using a combination of natural language instructions and demonstrations within or outside an extended reality environment. The architecture 800 can be used to assist the user 820 in creating and/or refining a rule or policy using a combination of natural language processing, object tracking, machine learning and artificial intelligence. The architecture 800 can also be used to determine a level of confidence in a rule or policy created and/or edited based on verbal instruction and/or physical demonstration by the user 820. The architecture 800 can communicate with the user 820 in a way in which the user 820 can combine, manipulate, update, etc. the rules or policies in an intuitive manner.

The extended reality environment of the present disclosure can be rendered, using the architecture 800 and can be rendered to a user 820 wearing and using any one of the extended reality systems 205, the augmented reality system 300, the virtual reality system 350, the HMD 465, and the augmented reality glasses 485. In some embodiments, the device(s) providing renderings, in environment 800, includes or otherwise is in communication with a natural language processor 810, a demonstration processor 818, a virtual assistant 830, a prediction model 840, a mode identification module 850, a rule or policy generator 860, and an input device 870. The combination of components can be provided using any combination of software and hardware within the client system 105, the virtual assistant engine 110, the remote system 115, or a combination thereof. For example, the input device 870, the virtual assistant 830 can be provided on the client system 105, the prediction model 840 and mode identification module 850 can be provided on the virtual assistant engine 110, and the natural language processor 810 and the rule or policy generator 860 can be included on a remote system 115.

The virtual assistant 830 can include any combination of virtual assistant components, for example, the virtual assistant 830 can be the virtual assistant application 130, virtual assistant engine 110, or a combination thereof. The virtual assistant 830 can be configured to receive input from the user 820 and provide one or more functionalities based on the user input, as discussed in greater detail herein. Within the architecture 800, the virtual assistant 830 can be configured to identify requests from the user 820 to create, modify, or delete one or more rules or policies utilized by the extended reality system. For example, the virtual assistant 830 can listen (e.g., using natural language processing) for voice commands, track user inputs within the extended reality environment, or receive input from another component within the architecture 800 indicating a desire to create, modify, or delete one or more rules or policies.

In some embodiments, the virtual assistant 830 can be configured to listen to user vocal input, track user actions and record user input/actions (e.g., via input device 870) for future use. For example, the virtual assistant 830 can store data to be used for training AI/ML for providing predictions (e.g., by prediction model 840), mode predictions (e.g., mode identification module 850) recommendations (e.g., by rule or policy generator 860), etc. by other components of the architecture 800.

The natural language processor 810 can be configured to extract features from a natural language explanation received by the architecture 800, for example, through interaction with the user 820 within an extended reality system 205, an augmented reality system 300, virtual reality system 350, HMD 465, and augmented reality glasses 485. For example, the natural language processor 810 can extract keywords from a narration received from the user 820. In some embodiments, the extracted features can include one or more events, conditions, and actions for a rule or policy and the connections between the one or more events, conditions, and actions. The natural language processor 810 can be initialized in response to receiving one or more trigger terms or phrases from the user 820. For example, if the user 820 mentions any keywords around “teach”, “train”, “learn” etc. then the architecture 800 automatically recognizes this as a candidate resource for further processing, specifically for creating a new rule or policy. In some embodiments, the natural language processor 810 can include a pre-processor 812, a pattern matching module 814, and a template generator 816.

In some embodiments, the pre-processor 812 can be configured to receive the initial audio input from the user 820 (e.g., via input device 870) and perform the initial processing/analysis of the audio input. The audio input can be received using any combination of systems or methods, such as for example through one of the input/outputs (I/O) interfaces 875 of the input device 870. For example, the input device 870 can be a wearable device having one or more audio sensors configured to capture audio input from the user 820. The audio input can include verbal natural language explanations or commands provided by the user 820, for example, directed to the virtual assistant 830 to perform one or more tasks.

The pre-processor 812 can be configured to segment the natural language explanation into sentences or utterances. Thereafter, using the sentences or utterances, the pre-processor 812 can tokenize the sentences or utterances to generate a list of words for each sentence or utterance. With the list of words generated, the pre-processor 812 can label parts of speech within the sentences and utterances based on the list of words for each sentence or utterance and detect named entities within the sentences and utterances based on the labeled parts of speech and the list of words for each sentence or utterance. The labeled parts, list of words, and named entities can then be used to make further determinations as to the intentions and desires of the user 820.

The pattern matching module 814 can be configured to extract various elements of the sentences or utterances based on the named entities, the labeled parts of speech, and the list of words for each sentence or utterance (e.g., as provided by the pre-processor 812). In some embodiments, the various elements can include one or more events, conditions, and actions for a rule or policy. The pattern matching module 814 can be configured to extract relationships between the various elements, the relationships including the connections between the one or more events, conditions, and actions. The pattern matching module 814 can be configured to extract various elements of the sentences or utterances based on the named entities, the labeled parts of speech, and the list of words for each sentence or utterance, with the various elements including the one or more events, conditions, and actions. The pattern matching module 814 can be configured to extract relationships between the various elements, with the relationships including the connections between the one or more events, conditions, and actions. Each of the extracting steps can be performed using any combination of pattern matching systems or methods.

In some embodiments, the template generator 816 can be configured to convert the one or more events (or contextual trigger), conditions (or contextual state), and actions and the connections between the one or more events, conditions, and actions, into a predefined output template that maintains the relationships between the one or more events, conditions, and actions based on the connections between the one or more events, conditions, and actions. For example, if a user wants to teach the system about the sequence of actions when they go out of the door, the user can wear an extended reality environment device (e.g., AR/MR glasses), and walk to different locations, point, look, and talk about different actions they expect the system to learn about. The user can walk to the door, and say, “If I am opening the front door and steps out of it, that means that it's likely that I am leaving the house.” In this case, the system can perform natural language processing to identify the logic words, such as “if . . . then . . . ”; and that the location related words, such as “door”, and action related words, such as “steps out of”. The system can further double check with these actions and objects based on what the video-based analysis is (e.g., there will be an object recognized in the video that's labeled as “door”, and there will be the actions recognized as “turning the doorknob”). In another example, the user can walk to the smart gas stove, and point at the gas stove, and say the system, “If I am leaving the house, then make sure that the gas stove is turned off. This is important.” And then the person walks to the back door and says, “also, please make sure that the back door is closed, and all the lights are shut off except the living room light, and all the blinds in the house are put down.” The natural language processing is similar to the above. Every time the person points or looks at a certain object, the system can recognize the semantics (label) of the object, but also remembers the locations of these objects. After all the steps in the sequence are done the user can end the learning session. For example, when the person says, “that's it. That's what a “leaving the house” action sequence is.” can identify to the system that it is the end of the instruction(s). By natural language processing, the sequence will be saved with a title, for example, the name of “leaving the house.” After the leaving the house policy is created, every time the person gets outside of the house, the virtual assistant can provide the suggestion of “do you want to carry out the leaving the house sequence?”, and the user can indicate yes or no.

In some embodiments, the natural language processor 810, and/or the virtual assistant 830 can coordinate with the prediction model 840 to evaluate what the user 820 is trying to convey. The prediction model 840 can provide logic and programming necessary to interpret actions and/or commands received from the user 820. The prediction model 840 can include a combination of logic and software to apply natural language processing, gesture analysis, artificial intelligence (AI) and/or machine learning (ML) to user 820 verbal instructions, physical actions (e.g., demonstrations), recurring behaviors, etc. to determine what a user is trying to convey or achieve. For example, the prediction model 840 can include or otherwise rely on a combination of model parameters 845 and the artificial intelligence systems 140 provided by the virtual assistant engine 110, discussed with respect to FIG. 1, to predict what a user is trying to teach the system.

In some embodiments, the prediction model 840 can be configured to predict a control structure including of one or more conditional statements based on the extracted features, extracted contextual features, and model parameters 845 learned from historical rules or policy information. The control structure can include all or part of the logic (conditions and actions) to create or modify a rule or policy. The conditional statements include the one or more conditions required for a given action to be triggered in a natural language statement (also referred to herein as a rule), e.g., If the user is holding a bowl in the kitchen, then open the recipe application. The processing for predicting a control structure can include determining a confidence score for predicting the control structure and comparing the confidence score to a mode threshold. In response to the confidence score being below the mode threshold, determining that additional information is required for the rule or policy. If additional information is required, the user 820 can be notified that additional information is required and what information may be required. In response to the confidence score being at or above the mode threshold, determining that the control structure is acceptable.

In some embodiments, the prediction model 840 can rely upon a combination of data for arriving at a prediction. The prediction model 840 can include a plurality of model parameters 845. The model parameters 845 can be learned weights/biases for various features and relationships between features learned from training data while training the model.

In some embodiments, the prediction model 840 can be configured to provide recommendations to the user. For example, if the user is trying to convey that they would like to create or modify a rule or policy, but it does not exactly match an existing command, the prediction model 840 can calculate a prediction for what the user desires. The prediction can use any combination of AI and ML while providing a confidence level for the prediction being provided to the user. The recommendations can be driven by a combination of data, including but not limited to historical data for the user, historical data for the environment, historical data for any referenced rule, policy, or object. The recommendations can also be refined and updated over time, for example, using training models.

In some embodiments, a demonstration processor 818 can be configured to provide supplemental data (e.g., to the prediction model 840). The supplemental data can be combined with the data provided by the natural language processor 810 to enhance the confidence of the predictions and/or rule or policy generation. For example, verbal input from the user 820 can be supplemented with a physical or virtual demonstration of one or more action(s) in the physical and/or virtual environment. In some embodiments, the demonstration processor 818 can receive tracking data from the input device 870 through any combination of I/O interfaces 875. For example, the demonstration processor 818 can receive input from a combination of cameras, motion sensors, accelerometers, etc. The tracking data received from the input devices 870 can include any combination of characteristics for the user 820. For example, the tracking data can include a combination of tracking motion of the user 820, tracking positioning of the user 820 in relation to other users or objects, tracking biometrics of the user 820, tracking a gaze of the user 820, etc. The received tracking data can be stored and/or processed to determine and/or establish a pattern or template for the physical or virtual movements of the user 820. For example, the tracking data can be stored to provide historical data on behavior of the user 820, such as daily policy, schedule, frequent interactions, etc.

The tracking data can be monitored at any given time period, either passively as an ongoing capturing during use of one or more input devices 870 within the extended reality environment or in response to a specific trigger or command to begin capturing. In one example, the architecture 800 can be configured to constantly capture and storing behavior of the user 820 when interacting with or otherwise in the presence of the extended reality environment. Constantly capturing and storing behavior of the user 820 can include capturing data from one device that the user 820 is frequently or constantly wearing (e.g., eyewear device 305) or it can be aggregated over a plurality of devices that the user 820 interacts with throughout the day. In one example, the architecture 800 can be configured to capture and storing behavior of the user 820 in response to a trigger. The trigger can be any combination of user triggered, system triggered, or event triggered. For example, the tracking data capturing can be triggered in response to the demonstration processor 818 receiving an input from the natural language processor 810 that the user provided a verbal instruction (e.g., via the virtual assistant 830) to create, modify, or delete one or more rules or policies. In another example, the demonstration processor 818 can initiate the tracking data capturing in response to receiving an instruction from the natural language processor 810 or the virtual assistant 830.

In some embodiments, the demonstration processor 818 can receive an instruction to being capturing tracking data as part of a user demonstration. For example, either the user 820 or the virtual assistant 830 can provide instructions that a physical or virtual demonstration is to be performed by the user 820. The demonstration can be provided to provide the basis for creating or modifying a rule or policy or to supplement the creation or modification of a rule or policy. For example, the demonstration processor 818 can capture tracking data for the user 820 and provide the data directly to the prediction module 840 for processing, to the natural language processor 810 for supplemental processing, or directly to the prediction module 840 to supplement data the prediction module 840 receives from the natural language processor 810.

In some embodiments, capturing a demonstration of the rule or policy from the user 820 can include capturing a series of images or frames.

In some embodiments, as part of a user demonstration, the demonstration processor 818 can be configured to extract contextual features from the captured tracking data during the demonstration. The contextual features can include context associated with the one or more conditions, context associated with one or more events, conditions, and actions and context associated with the connections between the one or more events, conditions, and actions. In some embodiments, the control structure, provided by the prediction model 840, is predicted based on the extracted features from the natural language processor 810, the extracted contextual features from the demonstration processor 818, and the model parameters 845 learned from the historical rule or policy information.

In some embodiments, the demonstration processor 818 can be configured to provide feedback to the user 820, for example, through input device 870. The feedback can be formatted to provide the user with a predicted rule or policy based on the user input, a request for additional information (e.g., if further demonstration is needed to form a prediction), a suggested rule or policy, etc. The feedback can be provided in the form of a visual or audio instruction, query, etc. or it can be a visual or audio representation rendered within the extended reality environment. In one example, the feedback can be generated within the extended reality environment, showing the user 820, within the environment, how the rule or policy was created, the effect of the rule or policy, etc. In some embodiments, the user can provide feedback back to the demonstration processor 818 to improve the effectiveness of an existing rule or policy. For example, the user 820 can prompt the architecture 800 to provide feedback, for example via a verbal or menu command to the virtual assistant 830, for a particular rule or policy. The feedback can be provided between the user 820 and the demonstration processor 818 literately (e.g., via virtual assistant 830, within the extended reality environment, etc.) until the user 820 is satisfied with the resulting rule or policy.

In some embodiments, the mode identification module 850 can be configured to identify a mode from a plurality of modes for determining the level of detail required for teaching or learning a rule or policy for the virtual assistant 830. The mode identification module 850 can also determine a mode for updating or modifying a rule or policy to better fit the preferences of a user. The modes can be determined based on some combination of a context of current user state, a complexity of the rule or policy, and a confidence level or score (e.g., by prediction module 840) compared to similar or related existing rule or policies. The similar or related existing rule or policies can be evaluated using a similarity score derived from historical rule and policy data to assist in determining a confidence score. The mode identification module 850 can be configured to notify the user 820 of the level or additional level of detail required for teaching or learning the rule or policy based on the determined mode. In some embodiments, the modes include a first mode that requires a natural language explanation, a second mode that requires a demonstration, and a third mode that requires a natural language explanation and a demonstration. The third mode can use the combination of a natural language narration combined with the demonstration corresponding to the narration to improve the confidence of the recommended rule or policy provided by the prediction module 840.

To determine the current context, the architecture 800 can observe the user 820 behavior (e.g., user activity, user biometrics, etc.), observe the surrounding environment (e.g., devices powered on, other users in the proximity, etc.), gather local information from one or more data sources (e.g., date, time, weather, etc.) and make a mode predication. The current context can include a level of activity or availability of the user, a time of day at the location of the user 820, how much information may be needed to teach or learn a rule or policy, a confidence level of the prediction of the desired control structure, or a combination thereof.

The modes can depend on the current context surrounding the user 820. In some embodiments, the modes can be based on coarse context (e.g., time of day, day of the week, calendar date, etc.) and coarse user state (e.g., user browsing the Internet, user working, user exercising, etc.). The mode identification module 850 can select an advanced teaching mode when it is observed (e.g., by checking calendar, time of day, user activity, historical data, etc.) the user has plenty of time and/or the confidence score is low. For example, if the user 820 is relaxed and its evening time, the mode identification module 850 could provide recommendations with high error rate/uncertainty for user editing.

Similarly, the mode identification module 850 can select a minimal teaching mode when the confidence score is high since it is pretty clear what rule or policy the user 820 wants to author. In some instances, the minimal teaching mode can include merely confirming with the user 820 their intentions. For example, if confidence is low and the user 820 is not relaxed and its early in the day, the mode identification module 850 could prompt the user 820 for quick feedback (e.g., was this recommendation useful, is this recommendation incorrect and would you like to bookmark this for later editing, etc.). In another example, if confidence is low and the user 820 is not relaxed the architecture 800 can prompt the user 820 (e.g., via I/O interfaces 875 can prompt the user 820), “Do you want to teach the system to do X?”.

In some embodiments, the rule or policy generator 860 can be configured to generate one or more rules or policies based on input form the user 820. The rules or policies can be created, for example, through a combination of natural language input and physical demonstration provided by the user 820. For purposes of this disclosure, generating new rules or policies can be used synonymously with teaching or learning behavior for the virtual assistant 830, for example, through artificial intelligence and/or machine learning. The rule or policy generator 860 can include any combination of components for facilitating the creation, modification, or deletion of rules or policies utilized by the extended reality system. The rules or policies can include any combination of programming or logic for carrying out a combination of functionalities provided through the virtual assistant 830. In some embodiments, the rule or policy generator 860 can be configured to generate rules or policies based on a control structure provided by the prediction model 840. The control structure for the rules or policies can include the one or more contextual events for executing one or more actions based on evaluation of one or more conditions. The rules or policies can include rules or policies for interacting with other elements or objects within a home, place of business, etc. For example, interacting with audio/video devices, lighting devices, entertainment devices, utility devices, sensor devices, fixtures, furniture, other users, etc.

In some embodiments, the rules or policies can include a combination of contextual events, conditions, and actions such that when a rule or policy is enabled, a system will monitor for device statuses or user activities (e.g., an event) that correspond to the contextual events defined by the rules or policies. When a contextual event is detected, and all the conditions for that event are satisfied, then the action is triggered. For example, a rule can include a door opening event that requires the system to monitor a door open sensor in combination with a condition for a door opening between 12 AM and 6 AM that will cause an action for a notification to be sent to the homeowner. Continuing the example, if the door is opened after 6 AM then the condition would not be satisfied, and even through the event of a door opening is satisfied, the action of a notification will not be triggered because the 12 AM-6 AM condition was not satisfied. A policy can be similarly formatted as the rule but may not be dependent on an action but rather will occur within predetermined periods of time. For example, a policy can be provided to turn on the living room light every day at 6 PM. Each of the contextual event, conditions, and an action can be elements of the rules or policies that can be viewed, modified, created, and/or deleted by a user.

In some embodiments, each of the base or generic rules and policies and specific rules and policies (e.g., rules and policies that have defined context events, conditions, and actions) can be stored in a data store. The rules or policies in the data store can include rules and policies that are pre-programmed, for example, by a developer or they can be customized rules or policies programmed by a user. The user can create customized rules or policies using the pre-programmed rules or policies as a base or template or they can be completely created from scratch. Rules, policies, and/or elements can be associated with physical or virtual objects (e.g., a piece of furniture) or grouped or clustered together into moods or programs for facilitating a defined style of living (including the control of multiple devices by the virtual assistant 830).

Continuing with FIG. 8, in some embodiments, the rule or policy generator 860 in combination with the virtual assistant 830 can be configured to assist the user 820 during the creation and/or modification of a rule or policy. The level of assistance can be provided depending on the sophistication level of the user and/or the mode provided. There are different levels of difficulty for authoring rules or policies. For example, the mode rule or policy generator 860 can provide out of the box rules or policies that require minimal user interaction to complete (e.g., filing in inputs fields within a template) or require some combination of natural language explanation and/or demonstrations be provided by the user 820. Similarly, the user 820 can create or modify rules using varying levels of involvement with the virtual assistant 830. For example, the user 820 can create or modify rules or routings without input or feedback from the virtual assistant 830, through following step by step guided instructions from the virtual assistant 830, or a hybrid of both. Guidance can also include brief or in-depth tutorials for modifying rules or policies. For example, the rule or policy generator 860 can show a user how a change to one or more parts of a rule or policy or how changes to a part of a rule or policy may affect the other parts of the rule or policy. The virtual assistant 830 can provide any combination of text, visual, or audio feedback to the user.

In some embodiments, the virtual assistant 830 can provide feedback to the user as to the quality, completeness, or functionality of a rule or policy. The feedback can be provided in any combination of visual effects. In some embodiments, to assist the user in debugging code, the virtual assistant 830 can emphasize elements that are creating an error. For example, if a user deletes an input value parameter that is required for a rule or policy to operate, then the virtual assistant 830 may provide feedback to reflect the issues or potential issues.

In some embodiments, the virtual assistant 830 can provide suggestions for correcting and/or optimizing code using a combination of AI/ML while providing confidence estimates (e.g., based on uncertainty) for each of the suggestions. The predication model 840 can track how a user is editing a rule or policy to determine what the user 820 is trying to achieve and can identify areas that are inefficient and suggest changes. For example, when the user provides a policy to turn off the upstairs lights around the house when the user is going to the bedroom around 11 PM, the system can query the user, “do you want to turn off the lights in the living room and kitchen?”. The suggestions can be provided through any combination of methods, such as audibly through the virtual assistant, visually through a graphical user interface, etc. These suggestions can be provided based on a high confidence that the suggested events, conditions, or actions may be related to the existing events, conditions, or actions, as determined by the prediction model 840.

In some embodiments, the user 820 can also request an “optimal” policy for a special context/use case from expert policy developers. The user can request that the virtual assistant 830 automatically generate a rule or policy for a specific task or goal. The virtual assistant 830 generated rules or policies can include creating a rule for a particular task and/or setting parameters for a rule or policy. For example, a user can request the virtual assistant 830 to make a rule for a welcome home policy or for setting an environment with ideal conditions for raising a particular plant. To generate such rules, policies, or rules and policy parameters, the virtual assistant 830 can refer to a library of variations of rules or policies (locally generated or generated over an entire network of users) and from Internet sources (e.g., ideal temperature, humidity, etc. for a plant). In some embodiments, virtual assistant 830 can update or reconfigure rules or policies that are currently being implemented by the user. The interconnected building blocks can be reconfigured by the AI based on its interaction with the user and learning of their preferences for the rules and policies.

In some embodiments, virtual assistant 830 can load rules or policies from templates, for example, from the templates database 870. The templates can provide a roadmap or building blocks foundation for the code for the rules or policies. The templates can be provided in a generic outline or shell that is an easy-to-understand and manipulate (e.g., change, add, remove, etc.) by a user. The generic outline or shell of the templates can include initial events (or contextual events), conditions, actions, or other programming to be used for building or modifying the generic rule or policy into a customized rule or policy fitting the task or goal desired by the user 820. For example, a template for turning on a light can have default values for context trigger events, conditions, and actions involving turning on a light source. Different templates can have different elements of the rules or policies that are editable and non-editable. For example, the action for the turn light policy might be locked (e.g., as turn on light instruction) but the context trigger event (e.g., user arrives home) and condition (e.g., after 6 PM) may be editable by the user. A user can utilize the templates loaded into the builder tool 890 user interface to select different rules or policies and edit the selected rules or policies to create new rules or policies.

In some embodiments, the virtual assistant 830 can be configured to automatically provide one or more templates based on the user or user activity and/or machine generated recommendations. The recommendations can be provided in response to a user inquiry or can be provided based on observed behavior of the user or other users. For example, if the user queries the virtual assistant “show me rules for lighting” or if the architecture receives a behavior that a user frequently manually turns on the lights when they arrive home at night. A user can choose to enable a recommended rule or policy without modification, or the user can use a combination of natural language explanations and demonstrations to customize one or more parts of the recommended rule or policy. For example, the user may want to add more devices to power on with the recommended ‘lights on’ rule. The additional devices may not have been part of the observed behavior because the user thought it was too manually effort. The additional devices can be added using a verbal command to add more lights or by walking around the house and turning on all the lights the user would like to turn on (i.e., through demonstration). In another example, the virtual assistant 830 can recommend modifications to a user created or modified rule or policy. For example, if the user creates a policy for turning on a light when they arrive home, the virtual assistant 830 can recommend adding a policy for adjusting a temperature on the thermostat prior to the user arriving home.

In some embodiments, pre-existing and recommended rules or policies (or other pre-existing rules or policies) can be used to modify other rules or policies. To modify a rule or policy with another rule or policy, a user provides a verbal explanation for which rule to mimic for another purpose. For example, if a user likes that the lights turn on when they arrive home, but they would also like music to play at the same time, the user can explain that when ‘lights on’ rule is active, also turn on music on the speakers to instill the context trigger and conditional requirements into a ‘music on’ rule while having a unique action (e.g., speakers on).

In some embodiments, the rule or policy generator 860 can be configured to associate, cluster, or group objects, rules, and/or policies based on a natural language explanation of demonstration provided by the user. Grouping objects, rules, and/or policies can be useful to combine a number of objects or interactions to trigger in response to the same event. For example, when a user arrives home, it may be beneficial to have a group of rules or policies associated with one or more objects to trigger at substantially the same time. The associating, clustering, and grouping can be any combination of verbal explanation via the virtual assistant 830 and demonstration provided by a user (e.g., via the extended reality environment). For example, manual groups can be formed by the user pointing to a bunch of different Internet enabled objects within the extended reality environment. In some embodiments, objects, rules, and/or policies can be grouped to create a mood or other situational programming. For example, groupings can be created for a wake-up policy, a welcome home policy, etc. in which several objects or devices are modified according to one or more rules or policies.

In some embodiments, the rule or policy generator 860 can be configured to enable a user to add cognitive states, tasks, and social context to a rule or policy. For example, a user can create a rule that launches a grocery shopping list whenever the user opens the fridge, which can be further modified with a social context to only open the list when the user alone, or only when the user is not rushing or distracted. In another example, if a wearable of the user is reading an increased temperature associated with increased heartrate, the rule or policy can cause a temperature of a thermostat to be slightly decreased. As discussed above, the rule or policy generator 860 allows the user to easily add in cognitive states, tasks, and social context to a rule or policy, for example, as part of the conditions for the rule or policy. Cognitive states, tasks, and social context states can be added as part of a new rule or policy creation or to previously existing rules or policies. The cognitive states, tasks, and social context can be automatically detected from a combination of sensors, wearable devices, image capturing device, audio capturing devices, etc.

In some embodiments, the rule or policy generator 860 can maintain a library of all the rules and policies, including different states (e.g., active or inactive) and variations for each of the rules or policies. For example, all the rules or policies can be stored in a data store. Additionally, the rules or policies can be sorted, filtered, categorized, grouped, etc. according to a number of criteria. The rule or policy generator 860 can also manage a list of all of the rules or policies that are currently active for monitoring. A user can search the library for all of the objects that have pre-existing rules or policies associated therewith. For example, a door object could have three related rules or policies, “check the weather when I get out of the door”, “turn on the security system when I get out of the door”, “check the key when I get out of the door”.

The rule or policy generator 860, can rely upon a combination of data for assisting the user 820 in creating new rules or policies. The data can be provided by a combination of the data store and a templates database. The data store and the templates database can include any combination of data storage for storing any combination of data necessary to implement the aspects of the present disclosure. For example, the templates database can include storage for pre-existing rules and policies as created by developers and rules and policies as created by users. Additionally, the templates database can be a separate data store from the data store or they can be part of the same storage unit.

In some embodiments, the virtual assistant 830 can coordinate with the rule or policy generator 860 to retrieve rules or policies for creation, modification, or deletion within the extended reality environment. Within the architecture 800, the virtual assistant 830 can be configured to identify requests from the user 820 to create, modify, or delete one or more rules or policies utilized by the extended reality system and the rule or policy generator 860 can facilitate the creation, modification, or deletion one or more rules or policies. The virtual assistant 830 can also work with the rule or policy generator 860 by providing input from the user and coordinating input from the prediction model 840. Input from the user can be exchanged using any combination of devices, for example, an extended reality system 205, an augmented reality system 300, virtual reality system 350, HMD 465, and augmented reality glasses 485.

### CAP Authoring (Defining and Modifying Using Natural Language and Demonstrations) Techniques

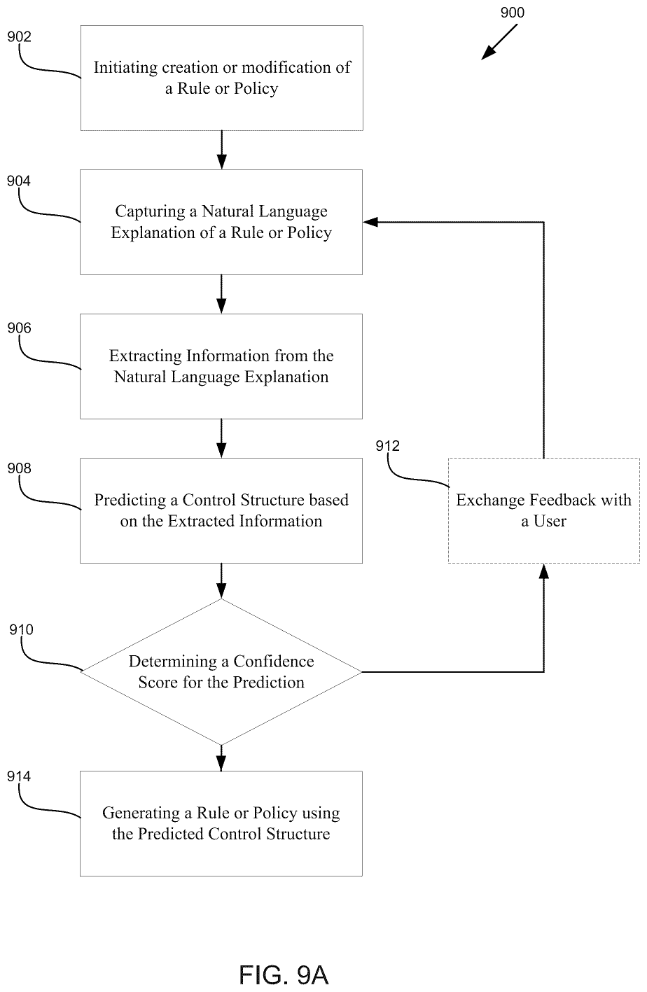

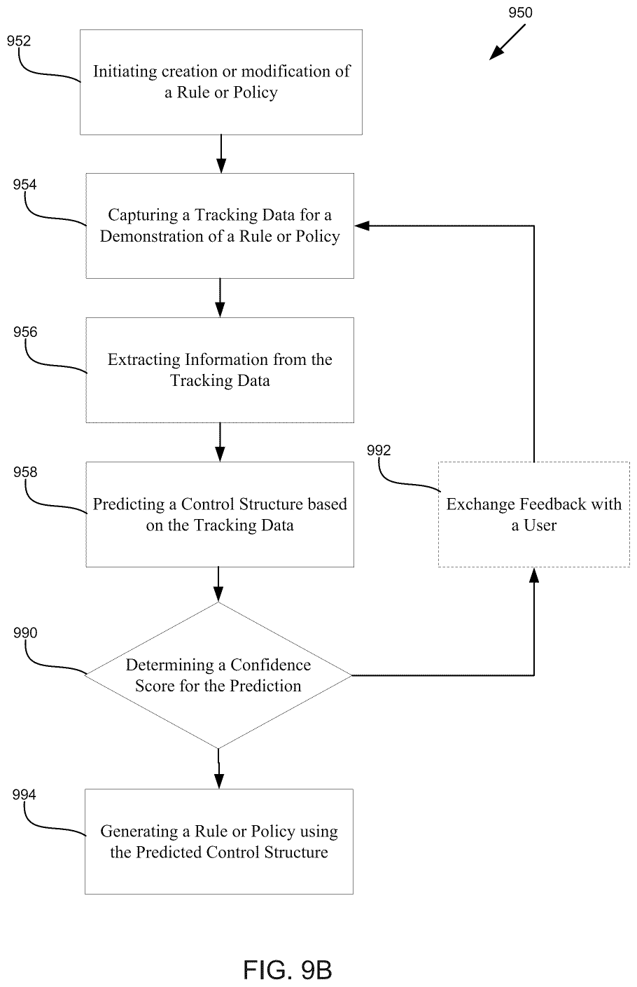

FIGS. 9A and 9B illustrate flow charts showing processes 900, 950 for defining and modifying behaviors implemented through a virtual assistant 830, specifically through the creation or modification of rules or policies. The virtual assistant 830 can be provided as part of an extended reality environment being provided through an extended reality system 205, an augmented reality system 300, virtual reality system 350, HMD 465, augmented reality glasses 485, or a combination thereof. The steps in processes 900, 950 can be performed by any combination of devices discussed herein, for example, any combination of computing devices 105, 110, 115 can be performed the various steps. The processing depicted in FIGS. 9A and 9B may be implemented in software (e.g., code, instructions, program) executed by one or more processing units (e.g., processors, cores) of the respective systems, hardware, or combinations thereof. The software may be stored on a non-transitory storage medium (e.g., on a memory device). The methods presented in FIGS. 9A and 9B and described below are intended to be illustrative and non-limiting. Although FIGS. 9A and 9B depict the various processing steps occurring in a particular sequence or order, this is not intended to be limiting.

Referring to FIG. 9A, process 900 includes steps for creating or modifying rules or policies using natural language processing, for example, by the natural language processor 810. In some embodiments, the rules or policies can include implementing functionality of the virtual assistant 830 itself, one or more devices that can interact with the virtual assistant 830 (e.g., smart devices), or a combination thereof.

At step 902, a request to create, modify, or delete a rule or policy for a given user or activity is received. The request can by caused by any combination of activities. For example, the request can be trigged by detecting a audio command or activation of a user interface element. The audio command can include any combination of predetermined keywords, such as “teach”, “train”, “learn” etc. For example, the user 820 could address the virtual assistant 830 with a verbal instruction to “create a new rule or policy”, “remove a rule or policy” update a rule or policy”, etc. The request can also be provided using other methods, such as via selection from a graphical user interface, making a predetermined gesture within an extended reality environment, or any other combination of methods. Once the request has been received, the process 900 can begin capturing audio for processing.

In some embodiments, prior to capturing the audio, the process 900 can determine a mode for the rule or policy based on the current state of the user, the complexity level of the rule or policy, the similarity score between the rule or policy and the historical rules or policies, or a combination thereof. The mode can be used to define a level of detail required for teaching or learning the rule or policy. After a user has initiated the command or trigger for the creation or modification of a rule or policy, the process 900 can notify the user of the mode and thus the level of detail required for learning the rule or policy based. The notification can be provided through any communication means, for example, through a visual or audio message played by the virtual assistant 830. There can be any number of modes that define the different levels of complexity. For example, there can be different modes for different types of information to be provided by the user. For example, there can be a first mode that requires a natural language explanation, a second mode that requires a demonstration by the user 820, and a third mode that requires a natural language explanation and a demonstration. The process being implemented depends on the mode. For example, the first and third mode may implement process 900, while the second and third mode may implement process 950.

At step 904, after a user has initiated the command or trigger for the creation or modification of a rule or policy, audio around the user can be captured by the natural language processor 810 for processing. In some embodiments, the audio being captured is a natural language explanation of a rule or policy from the user. The audio can be captured using any combination of systems or methods. For example, the audio can be collected from a device, having one or more audio sensors (e.g., microphone, acoustic sensor, etc.), being worn or accessed by the user. In some embodiments, the natural language processing can be performed on text provided to the natural language processor 810. The capturing can be performed for a predetermined period of time after initiating the creation or modification of a rule or policy. For example, the audio can be captured for the next 30 seconds, 1 minute, 5 minutes, etc. The predetermined period of time can vary depending on mode and/or the level of information needed for generating a rule or policy, sophistication of the user, the medium in which the rule is being generated, etc.

At step 906, the natural language processor 810 extracts features from the natural language explanation of the rule or policy from the captured audio using syntax and/or semantic analysis. The features can include any combination of data that is useable for discerning the intentions or desires of the user, using artificial intelligence, machine language, etc. For example, the features can be extracted using any combination of tokenization, part-of-speech tagging, pependency parsing, constituency parsing, lemmatization and stemming, stopword removal, word sense disambiguation, named entity recognition (NER), rules-based system, machine learning based systems, etc.

In some embodiments, the features include one or more events, conditions, and actions and connections between the one or more events, conditions, and actions. To extract the one or more events, conditions, and actions and connections, the natural language processor 810 segments the natural language explanation into sentences or utterances, tokenizes the sentences or utterances to generate a list of words for each sentence or utterance, and labels parts of speech within the sentences and utterances based on the list of words for each sentence or utterance. Using the labeled list of words, the natural language processor 810 can detect named entities within the sentences and utterances based on the labeled parts of speech and the list of words for each sentence or utterance.

In some embodiments, the natural language processor 810 can extract, using pattern matching, various elements of the sentences or utterances based on the named entities, the labeled parts of speech, and the list of words for each sentence or utterance. The various elements can include the one or more events, conditions, and actions and relationships between the various elements (e.g., the connections between the one or more events, conditions, and actions). Thereafter, the natural language processor 810 can convert the one or more events, conditions, actions, and the connections between the one or more events, conditions, and actions, into a predefined output template that maintains the relationships between the one or more events, conditions, and actions based on the connections between the one or more events, conditions, and actions. Regardless of the method of processing and type of information extracted through natural language processing, the natural language processor 810 can provide the information to the prediction model 840 for additional processing. For example, the natural language processor 810 can provide a processed natural language input to the prediction model 840 for evaluation and to form a prediction for what the user is saying.

At step 908, the prediction model 840 can interpret or assist in the interpretation of the processed natural language from the natural language processor 810 and determine whether the user is requesting to create, modify, or delete a rule or policy or some other task. For example, the prediction model 840 can predict whether the user is wanting to create or modify a particular rule or policy, identifying a rule or policy the user would like to create or modify, identifying one or more events, conditions, and actions to be defined for a rule or policy, etc. In some embodiments, the prediction model 840 can predict a control structure for a rule or policy from the information provided by the natural language processor 810 from step 906. The control structure can include one or more conditional statements based on the extracted features and model parameters 845 learned from historical rules or policies.

In some embodiments, the prediction model 840 can determine that the user is attempting to create or modify a rule or policy related to a predetermined template. For example, there can be a template related to a rule or routing for turning lights on, such that when part of the natural language processing determines that the use wants to create or modify a rule or policy related to turning light on, the lights on template may be predicted. The template can include a plurality of the initial values for each of the one or more events, conditions, and actions to be defined by the user using the processed natural language. Continuing the above example, the template for turning on lights can include separate parameters for events (e.g., entering a room), conditions (e.g., at night) and actions (e.g., turn off lights on). Part of the prediction by the prediction model 840 can include searching the processed natural language input for terms or phrases that may correspond to each of the triggers, conditions, and actions.

For example, if the user needs to modify the sequence of “leaving the house”, they could either click a button to modify or simply say, “I'd like to modify the sequence of leaving the house”. The interface will show them a sequence of the actions already authored, the user could click a specific action or continue to use the voice input. The user could say, “instead of the detecting me to get out of the door, carry out the action when I am at least 10 meters away from the house, and when there is nobody else in the house”. In some embodiments, the virtual assistant 830 can seek clarification. For example, the virtual assistant 830 may not know how to tell if anyone is inside the house, so the virtual assistant 830 prompt the user (either by audio or by a dialogue UI): “how can I tell if anyone is inside the house?”. In response, the user can instruct, “Connect to the motion sensors in the house, if there is no motion detected for 5 minutes, then it's considered to be nobody in the house.” The prediction model 840 can identify this new condition as the trigger for the “leaving the house” rule or policy (or sequence), and confirm with the user. After the confirmation, the updated rule or policy can be activated.

In some embodiments, modification of a rule or policy can include providing a prediction based on a natural language explanation for changing to an initial value for one or more of events, conditions and actions provided in the initial structure. The one or more of events, conditions and actions, and the initial values for the one or more of events, conditions and actions for the template can be configured by a developer or inferred by a model from historical rules or policies, historical behavior of the user, or a combination thereof.

In some embodiments, modification of a rule or policy can include providing a prediction based on a natural language explanation for associating the rule or policy with one or more physical objects, virtual objects, or combinations thereof and identifying one or more additional rules or policies based on the association with the one or more physical objects, virtual objects, or combinations thereof. In some embodiments, modification of a rule or policy can include providing a prediction based on a natural language explanation for grouping the rule or policy with one or more additional rules or policies as a defined style of living. In some embodiments, modification of a rule or policy can include providing a prediction based on a natural language explanation for grouping the one or more additional rules or policies with the rule or policy as a defined style of living. Grouping the rule or policy with one or more additional rules or policies into a mood, personality, or recipe for facilitating a defined style of living, wherein the grouping is performed based on similarities between the actions and the conditions.

Continuing with process 900, at step 910, the prediction model 840 can determine a confidence score for the prediction(s) derived in step 908. The confidence score (or probability) can be derived using any combination of systems or methods. The confidence score can be an indicator as to the level of confidence the prediction model 840 has in making a prediction. For example, a probability of 70% for predicting the creation, modification, or deletion of a rule or policy or some other task means the prediction model 840 is 70% confident that the observations point towards such activity.

In some embodiments, the determined confidence score can be compared against a mode threshold value. The mode threshold value can be any value and can be a predetermined value, a user selected value, or a machine learning determined value. The mode threshold value can be used to determine whether or not the confidence score is at a sufficient level to be dependable (e.g., through testing or historical proof). If the confidence score meets or exceeds the mode threshold value, then the score is sufficient to determine that the compared value (i.e., the control structure) is acceptable and the process 900 can advance to step 914. If the confidence score is under the mode threshold value, then the score is insufficient and the process 900 can advance to step 912 to notifying the user that the additional information for improving its confidence score.

At step 912, the process 900 exchanges feedback with a user regarding the need for additional information to improve the confidence score in order to provide an adequate prediction of the instructions provided by the user. In some embodiments, the feedback can be requested by the process 900 in response to the confidence score being below a mode threshold value. The request for additional information can be provided in any combination of systems or methods. For example, an audio and/or visual prompt of “additional information required” can be presented to the user 820 via the virtual assistant 830. In some embodiments, the feedback can include specific parameters that are needed from the user. For example, if a user is attempting to setup a “lights on” policy, but fails to provide a time or event for turning on the lights, the virtual assistant 830 can prompt the user to provide an event and/or a condition for the action of turning the lights on. In response to the prompt the process 900 can receive a natural language explanation from the user 820, which can then be provided back to step 904 to be processed.

In some embodiments, as part of (e.g., step 912) or in addition to the steps in process 900, the user 820 can provide feedback about a rule or policy back to the architecture for correction or clarification. For example, the user 820 can observe that a rule or policy is not operating as intended and provide feedback to the architecture to correct or further modify the rule or policy. The user feedback can be provided in response to a activation of a new rule or policy or it can be triggered based on an instruction or commend received from the user to update a given rule or policy. The user initiated feedback can be provided in a similar or different manner from the process 900 initiated feedback discussed above.

At step 914, after the confidence score meets a given value, a rule or policy is generated based on the predicted control structure in step 908. The rule or policy can include a combination of an event(s) and one or more conditional statements for executing one or more actions, based on evaluation of the one or more conditions. Each creation of a new rule or policy can be saved within a data store, even if they are built using a template. For example, the new rule or policy can be saved as a separate instance representative of the rule or policy in a data store including executable rules and policies, while the original template remains unchanged within the data store. In some embodiments, the process 900 can optionally provide additional feedback to the user 820 based on the generated rule or policy. Once a rule or policy is generated and stored, the architecture 800 can monitor for the events and conditions for activating or deactivating a rule or policy (i.e., the control structure) and execute the rule or policy when those occur. The executing can include detecting an event, evaluating one or more conditions, and executing the one or more actions based on the evaluation of the one or more conditions.

As would be appreciated by one skill in the art, rules or policies can include different combinations of activation criteria, such that not both events (or contextual triggers) or conditions need to be required for a rule or policy to work. For example, a rule for maintaining temperature in a freezer at zero degrees can merely monitor for a conditional change in temperature and then action for activating the freezer to adjust the temperature. Similarly, rules or policies can include any number of events, conditions, and actions. For example, there can be a plurality of conditions for a single action or a plurality of actions for a single condition.

Referring to FIG. 9B, process 950 includes steps for creating or modifying rules or policies using tracking data captured during a demonstration within a real world and/or extended reality environment. The demonstrations can be monitored and tracking data can be captured and processed by a demonstration processor 818. The data captured from a demonstration can include any combination of information. For example, data from a demonstration (e.g., tracking data) can include any combination of tracking physical movements of a user, tracking a gaze of a user (what a user is looking at), tracking biometrics of a user, etc.

At step 952, a request to create, modify, or delete a rule or policy for a given user or activity is received. The request can by caused by any combination of activities, for example, as discussed with respect to step 902 of process 900. In some embodiments, the request can specify to include a demonstration, separate from or in addition to a natural language explanation (e.g., as discussed with respect to process 900). Once the request has been received, the process 950 can begin capturing a demonstration by the user for processing. In some embodiments, prior to capturing the demonstration of a rule, the process 950 can determine a mode for the rule or policy, as discussed with respect to process 900. As discussed above, there can be a first mode that requires a natural language explanation, a second mode that requires a demonstration by the user 820, and a third mode that requires a natural language explanation and a demonstration. The process being implemented depends on the mode. For example, the first and third mode may implement process 900, while the second and third mode may implement process 950.

At step 954, after a user has initiated the command or trigger for the creation or modification of a rule or policy, tracking data around the user performing a demonstration can be captured by the demonstration processor 818 for processing. In some embodiments, the tracking data being captured is a physical and/or virtual demonstration of a rule or policy, performed the user. The tracking data can be captured using any combination of systems or methods. For example, the tracking data can be collected from a device, having one or more image sensors (e.g., image sensor, camera, etc.), being worn or accessed by the user. In some embodiments, the demonstration processing can be performed on tracking data provided to the demonstration processor 818. The capturing can be performed for a predetermined period of time after initiating the creation or modification of a rule or policy, for example, as discussed with respect to step 904.

At step 956, the demonstration processor 818 can extract features from the demonstration of the rule or policy from the captured tracking data using image analysis. The features can include any combination of data that is useable for discerning the intentions or desires of the user, using a combination of image analysis, artificial intelligence, machine language, etc. For example, the features can be extracted using any combination of analog and digital image analysis, pattern recognition, machine learning based image analysis, etc. Similarly, the features can be extracted from an analysis of a whole recorded demonstration as a whole, partial clips of the demonstration, frame by frame, or some combination thereof.

In some embodiments, the features include one or more events, conditions, and actions and connections between the one or more events, conditions, and actions or context related thereto. Thereafter, the demonstration processor 818 can convert the one or more events, conditions, actions, and the connections between the one or more events, conditions, and actions, into a predefined output template that maintains the relationships between the one or more events, conditions, and actions based on the connections between the one or more events, conditions, and actions. Regardless of the method of processing and type of information extracted from the tracking data, the demonstration processor 818 can provide the information to the prediction model 840 for additional processing. For example, the demonstration processor 818 can provide a processed tracking data input to the prediction model 840 for evaluation and to form a prediction for what the user is trying to demonstrate.

At step 958, the prediction model 840 can interpret or assist in the interpretation of the tracking from the demonstration processor 818 and determine whether the user is requesting to create, modify, or delete a rule or policy or some other task, for example, as discussed with respect to step 908. In some embodiments, the prediction model 840 can predict a control structure for a rule or policy from the information provided by the demonstration processor 818 from step 956. The control structure can include one or more conditional statements based on the extracted features and model parameters 845 learned from historical rules or policies. In some embodiments, the prediction model 840 can determine that the user is attempting to create or modify a rule or policy related to a predetermined template, for example, as discussed with respect to step 808. For demonstrations, part of the prediction by the prediction model 840 can include searching the tracking data input for gestures or movements that may correspond to gestures or moves in predetermined rule or policies or templates thereof. In some embodiments, the templates can include a demonstration that is viewable by the user 820 within an extended reality environment. Similarly, rules or policies created by the user 820 can be rendered within the extended reality environment for future review by the user 820 and/or other users.

The modification of a rule or policy can include providing a prediction based on a demonstration for changing to an initial value for one or more of events, conditions and actions provided in the initial structure, as discussed above. In some embodiments, modification of a rule or policy can include providing a prediction based on an a demonstration for associating the rule or policy with one or more physical objects, virtual objects, or combinations thereof and identifying one or more additional rules or policies based on the association with the one or more physical objects, virtual objects, or combinations thereof. For example, the user 820 can point to a number of different objects in a room for which the user 820 wants to create or modify a rule or policy as a group. Grouping rules or policies can be provided as discussed in greater detail herein.

Continuing with process 950, at step 960, the prediction model 840 can determine a confidence score for the prediction(s) derived in step 958, for example, as discussed with respect to step 910.

At step 962, the process 950 exchanges feedback with a user regarding the need for additional information to improve the confidence score in order to provide an adequate prediction of the instructions provided by the user, for example, as discussed with respect to step 912. In some embodiments, process 950 can prompt the user to provide a demonstration of all or part of the rule or policy. For example, the prediction model 840 can determine that all or part of the rule or policy needs additional information to function (e.g., via comparison to a template) and request the user provide said information through one or more demonstrations.

In some embodiments, as part of (e.g., step 962) or in addition to the steps in process 950, the user 820 can provide feedback about a rule or policy back to the architecture for correction or clarification, for example, as discussed with respect to step 912. The user can provide feedback in a manner similar to the feedback when requested by the architecture. If an observed rule or policy is observed by the user as not working properly, the user can enter a debug mode, identify a failing event, condition, and/or action for the rule or policy, and provide feedback in the form of a demonstration or add modifiers to have the rule or policy updated. For example, if a user creates a rule to turn on a desk light when a mug his placed on the desk, the prediction model 840 may initially create a rule that only turns on the desk light when the specific mug from the demonstration is placed in a specific location on the desk in a specific orientation. To improve the function of this rule, the user can enter a debug mode and provide multiple demonstrations of placing mugs on the desk. The demonstrations can include placing different mugs on the desk, placing mugs at different locations, and placing mugs at different orientations. With each demonstration, the prediction model 840 can learn and be updated to more accurately execute the rule as intended by the user.

In some embodiments, the user can coordinate with the prediction model 840 to identify aspects of a rule or policy that may need further refinement. For example, the prediction model 840 can provide accuracy estimates based on confidence for each of the event, condition, and/or action in a rule or policy, and the user can choose to provide prediction model 840 with one or more demonstrations for highly uncertain events, conditions, and/or actions. Every round of feedback allows the architecture 800 to adapt to user preferences and personality while the user learns about the capabilities of the architecture 800. As feedback is provided, the confidence is iteratively updated through steps 904-910.

At step 964, after the confidence score meets a given value, a rule or policy is generated (and can be executed) based on the predicted control structure in step 958, for example, as discussed with respect to step 914. In some embodiments, individual steps within processes 900, 950 can be used to supplement either or both of the respective processes. For example, step 912 or step 962 can trigger a request to supplement the respective process (i.e., process 900) by gathering additional information using the other process (i.e., process 950). Continuing the example, step 910 of process 900 can determine that the confidence score is below a given threshold and the feedback step 912 can determine that a demonstration by the user can improve the confidence value. Thereafter, the process 950 can be called to execute at least step 954-956 to provide the additional information of the tracking data from a user demonstration to step 908 of process 900. This additional information supplementation can work for either process 900, 950 and using any combination of steps from those processes. Alternatively, each of the steps from 900, 950 can be combined into a single process with various steps being executed when appropriate.

In some embodiments, processes 900, 950 can be used separately to supplement one another. For example, the user can first provide a natural language explanation for a rule or policy to be processed through process 900. As part of the confidence evaluation (step 910) feedback (step 912) in process 900 the prediction model 840 can determine that a base rule or policy while identifying one or more parameters of the rule or policy requiring additional input from the user, best provided through demonstration. Thereafter, the prediction model 840 can prompt the user to demonstrate the parameters for the identified lacking portions of the rule or policy. This enables a user to clarify a rule or policy without having to provide a demonstration for the entirety of the rule or policy. Similarly, as part of the confidence evaluation (step 960) feedback (step 962) in process 950 the prediction model 840 can determine that a base rule or policy while identifying one or more parameters of the rule or policy requiring additional input from the user, best provided through natural language explanation. For example, the prediction model 840 can provide a graphical demonstration (or playback of a user demonstration) for a rule or policy and request that the user provide narration explaining what is occurring during the demonstration.

In some embodiments, the processes 900, 950 can be used together to create a rule or routing. The use the processes 900, 950 together, the user 820 can perform a demonstration while substantially simultaneously explaining in plain language (or pseudo code language) what they are demonstrating. During such a combined process, the architecture can substantially simultaneously capture audio data and tracking data and process said data to form one or more predictions for rules or policies. The combination of the natural language explanation (being processed by the natural language processor 810) and the demonstration (being processed by the demonstration processor 818) can also be used in combined to improve the accuracy or confidence of the prediction model 840.

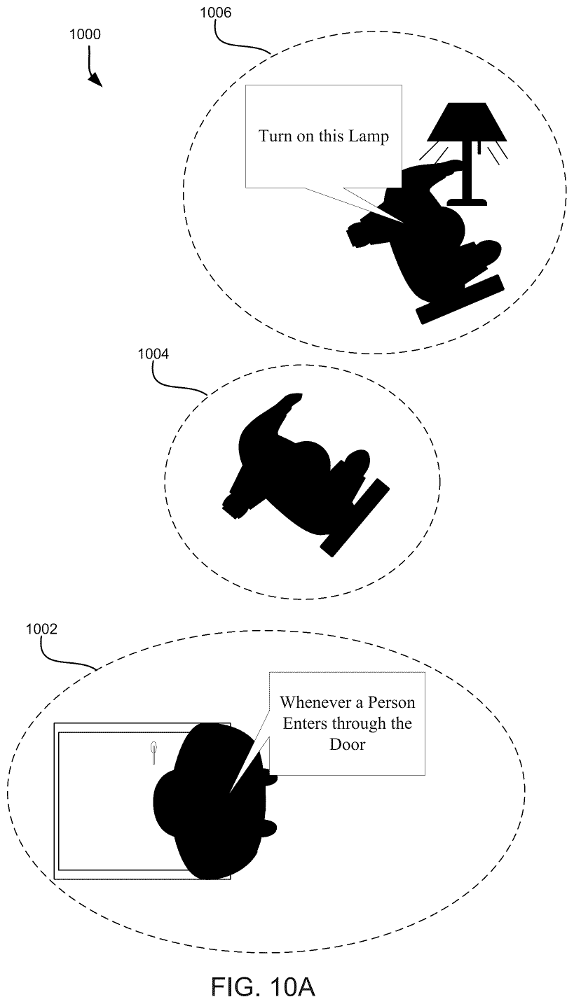

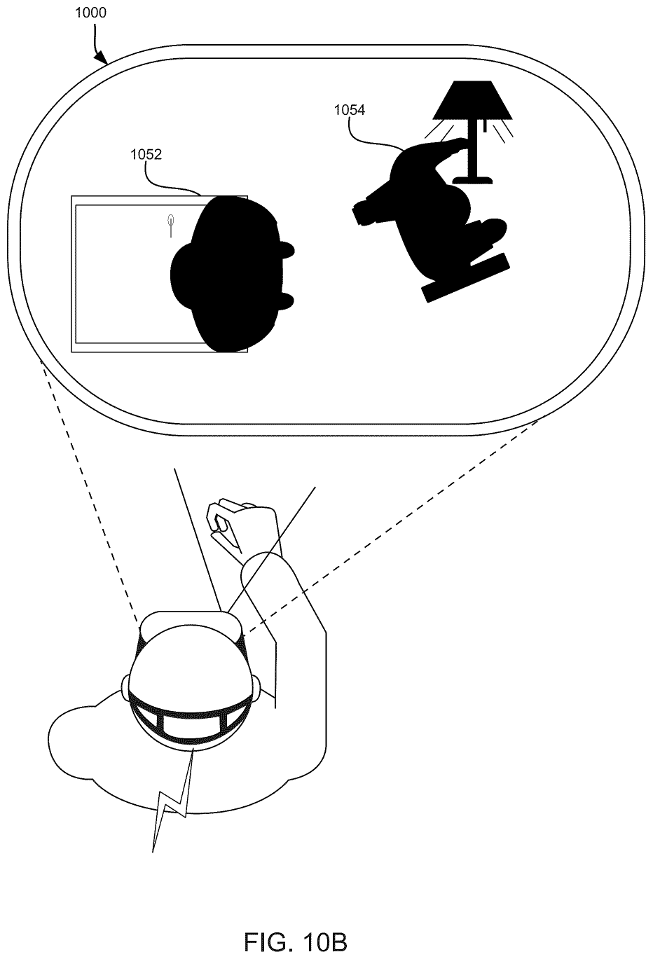

FIGS. 10A and 10B show example demonstrations 1000 that can be performed by a user to create or modify rules or policies using a virtual assistant 830 and/or within an extended reality environment. FIG. 10A depicts a user demonstrating, in the real world, a rule for turning on a light when a user enters the room. The demonstration can be initiated by the architecture 800 or by the user 820. For example, the virtual assistant can receive an instruction from the user 820 to start demonstration of a rule or policy using narration. Thereafter, the virtual assistant 830 can begin capturing an audio for the natural language explanation and motion tracking data for the demonstration.

At step 1002 of the demonstration, the user enters through a door and narrates, “Whenever a Person Enters through the Door”. At step 1004 of the demonstration, the user approaches a lamp without saying anything. At step 1006 of the demonstration, the user turns on the lamp while stating, “Turn on this Lamp”. The combination of the physical demonstration and the narration can then be processed by the natural language processor 810 and the demonstration processor 818 and provided to the prediction model 840 for analysis. The prediction model 840 can then predict a rule or policy to be created based on the analysis. For example, based on the received processed input data, the prediction model 840 can identify objects of the door, the user, and the lamp with actions of opening the door and turning on the light. Continuing the example, the prediction model 840 can then identify a rule or policy that the above parameters can be input (e.g., a turn light on rule). The turn light on rule can have an event parameter and an action item. Based on the data from FIG. 10A, the event parameter can be updated with door opening detection (or user proximity to door detection) and the action parameter can be updated with the light on action.

In some embodiments, the demonstration and natural language explanation can each be broken down into segments and paired to create the data necessary for predicting the user's intentions. For example, the demonstration in FIG. 10A can be segmented into three sections 1002, 1004, 1006 and each segment can be separately processed. Not all of the segments may be useful in making a prediction. For example, since there is no identifiable parameter, the prediction model 840 can determine that segment 1004 is not intended to be part of a rule or policy, so it can be dismissed.

FIG. 10B depicts a user demonstrating, in an extended reality environment, a rule for turning on a light when a user enters the room. The demonstration can be initiated by the architecture 800 or by the user 820 using any extended reality system, such as system 200 depicted in FIG. 2 and provided as an example in FIG. 10B. For example, the virtual assistant can receive an instruction from the user 820 to start demonstration of a rule or policy using narration. Thereafter, the virtual assistant 830 can begin capturing an audio for the natural language explanation and graphical tracking data for the demonstration.

At step 1052 of the demonstration, the user provides a graphical representation of a user entering through a door and optionally narrates, “Whenever a Person Enters through the Door”. At step 1054 of the demonstration, the user provides a graphical representation of a user turning on a lamp while optionally stating, “Turn on this Lamp”. The combination of the virtual demonstration and the narration can then be processed by the natural language processor 810 and the demonstration processor 818 and provided to the prediction model 840 for analysis. The prediction model 840 can then predict a rule or policy to be created based on the analysis, as discussed with respect to FIG. 10A.

In some embodiments, the user can view demonstrations of completed rules or policies in the extended reality environment. The demonstrations of rules or policies can provide guidance to the user on how to properly demonstrate rules or policies and/or particular events, conditions, or actions. Additionally, the user can search for pre-existing demonstrations which can be used when demonstrating a new rule or policy. For example, a user can search for the demonstration showing how to turn on a light. By searching for then mimicking known demonstrations, the predictions for a new rule or policy using those demonstrations can be generated by the system at a higher confidence level. In some embodiments, the user can refine demonstrations to teach or improve the learning of the prediction model 840. For example, a user can identify the action for turning on a light then provide numerous different demonstrations for turning on different types of lights, different shaped lights, etc. so the system can learn about turning on lights. This can include demonstrating different ways of turning on a light, for example, using a light switch, using a command to the virtual assistant, using a switch on the light itself, etc. Similarly in instances when the prediction model does not understand an aspect of a rule or policy, it can request the user provide one or more demonstrations to teach the prediction model that aspect.

The example demonstrations provided in FIGS. 10A and 10B are not intended to be limiting and any combination of natural language explanation, demonstrations, or both can be provided by a user to teach the system various rules or policies (or aspects thereof). For example, instead of operating a light as discussed above, a user provides a natural language explanation stating, “whenever I double tap an item in my fridge, add it to my shopping list” while providing a demonstration including the user physically double tapping items, pointing to items, and/or looking (e.g., eye gaze) at the items to create a rule for generating a shopping list.

### Illustrative Device

FIG. 11 illustrate an electronic device 1100 in accordance with various embodiments. The electronic device 1100 can be implemented in various configurations in order to provide various functionality to a user. For example, the electronic device 1100 can be implemented as a wearable device (e.g., a head-mounted device, smart eyeglasses, smart watch, and smart clothing); a communication device (e.g., a smart phone, cellular phone, mobile phone, wireless phone, portable phone, radio telephone, etc.); a home automation controller (e.g., controller for an alarm system, thermostat, lighting system, door lock, motorized doors, etc.); a gaming device (e.g., a gaming system, gaming controller, etc.); a vehicle (e.g., an autonomous vehicle); and/or other computing device (e.g., a tablet computer, phablet computer, notebook computer, laptop computer, etc.). The foregoing implementations are not intended to be limiting and the electronic device 1100 can be implemented as any kind of electronic or computing device that can be configured to provide an extended reality system using a part of or all the methods disclosed herein.

The electronic device 1100 includes processing system 1108. Processing system 1108 includes one or more memories 1110, one or more processors 1112, and RAM 1114. The one or more processors 1112 can read one or more programs from the one or more memories 1110 and execute them using RAM 1114. The one or more processors 1112 can be of any type including but not limited to a microprocessor, a microcontroller, a graphical processing unit, a digital signal processor, an ASIC, a FPGA, a PLD, or any combination thereof. In some embodiments, the one or more processors 1112 can include a plurality of cores, one or more coprocessors, and/or one or more layers of local cache memory. The one or more processors 1112 can execute the one or more programs stored in the one or more memories 1110 to perform the operations and/or methods, including parts thereof, disclosed herein.

The one or more memories 1110 can be non-volatile and can include any type of memory device that retains stored information when powered off. Non-limiting examples of memory include electrically erasable and programmable read-only memory (EEPROM), flash memory, or any other type of non-volatile memory. The one or more memories 1110 can include non-transitory computer-readable storage media from which the one or more processors 1112 can read instructions. A computer-readable storage medium can include electronic, optical, magnetic, or other storage devices capable of providing the one or more processors 1112 with computer-readable instructions or other program code. Non-limiting examples of a computer-readable storage medium include magnetic disks, memory chips, read-only memory (ROM), RAM, an ASIC, a configured processor, optical storage, or any other medium from which a computer processor can read the instructions.

The electronic device 1100 also includes one or more storage devices 1118. The one or more storage devices 1118 can be configured to store data received and/or generated by the electronic device 1100. The one or more storage devices 1118 can include removable storage devices, non-removable storage devices, or a combination thereof. Examples of removable storage and non-removable storage devices include magnetic disk devices such as flexible disk drives and HDDs, optical disk drives such as compact disk (CD) drives and digital versatile disk (DVD) drives, SSDs, and tape drives.

The electronic device 1100 also includes sensor system 1102. The sensor system 1102 can be configured to acquire information from an environment surrounding the electronic device 1100. Sensor system 1102 can include one or more devices that are configured to transmit and receive various signals (e.g., light, ultrasonic, radar, lidar, and the like) used for acquiring information from an environment surrounding the electronic device 1100. Examples of devices that can be included in the sensor system 1102 include digital and electronic cameras, light field cameras, 3D cameras, image sensors, imaging arrays, ultrasonic sensors, radar sensors, range sensors, LiDAR sensors, and the like.

The electronic device 1100 also includes communication system 1104. The communication system 1104 can include one or more devices that are configured to enable the electronic device 1100 to communicate with various wired or wireless networks and other systems and devices. Examples of devices included in communication system 1104 include wireless communication modules and chips, wired communication modules and chips, chips for communicating over local area networks, wide area networks, cellular networks, satellite networks, fiber optic networks, and the like, systems on chips, and other circuitry that enables the electronic device 110 to send and receive data.

The electronic device 1100 also includes user interface system 1106. User interface system 1106 can include one or more devices that are configured to display images, video, and other content and receive input from a user of the electronic device 1100. Examples of devices included in the user interface system 1106 include a liquid crystal display, a light emitting diode display, an organic light emitting diode display, a projector display, a touchscreen display, and the like.

The electronic device 1100 also includes orientation system 1120. The orientation system 1120 can include one or more devices that are configured to determine an orientation and posture of the electronic device 1100 and a user of the electronic device 1100. Examples of devices included orientation system 1120 include global positioning system (GPS) receivers, ultra-wideband (UWB) positioning devices, Wi-Fi positioning devices, accelerometers, gyroscopes, motion sensors, tilt sensors, inclinometers, angular velocity sensors, gravity sensors, and inertial measurement units, and the like.

The electronic device 1100 also includes audio system 1122. The audio system 1122 can include one or more devices that are configured to record sounds from an environment surrounding the electronic device 1100 and output sounds to the environment surrounding the electronic device 1100. Examples of devices included in audio system 1122 include microphones, speakers, and other audio/sound transducers for receiving and outputting audio signals and other sounds.

The electronic device 1100 also includes power system 1124. The power system 1124 can include one or more components configured to generate power, receive power, provide power, manage power, or a combination thereof. Examples of components included power system 1124 include batteries, power supplies, charging circuits, solar panels, power management circuits, transformers, power transfer circuits, and other components that can be configured to receive power from a source external to the electronic device 1100 and/or generate power and power the electronic device 1100 with the received or generated power.

The electronic device 1100 also includes a peripheral system 1126. The peripheral system 1126 can include one or more components configured to receive an input and/or provide an output. Examples of such input components can include a mouse, a keyboard, a trackball, a touch pad, a touchscreen display, a stylus, data gloves, and the like. Examples of such output components can include holographic displays, 3D displays, projectors, vibrators, actuators, and the like.

The foregoing configurations of the electronic device 1100 are not intended to be limiting and the electronic device 1100 can include other devices, systems, and components.

### ADDITIONAL CONSIDERATIONS

Although specific examples have been described, various modifications, alterations, alternative constructions, and equivalents are possible. Examples are not restricted to operation within certain specific data processing environments but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. An extended reality system comprising:
a head-mounted device comprising a display-to-display content to a user, one or more audio sensors to capture audio, and one or more cameras to capture images of a visual field of the user wearing the head-mounted device;
one or more processors; and
one or more memories accessible to the one or more processors, the one or more memories storing a plurality of instructions executable by the one or more processors, the plurality of instructions comprising instructions that when executed by the one or more processors cause the one or more processors to perform operations comprising:
capturing, using the one or more audio sensors, a natural language explanation of a rule or policy from the user;
extracting features from the natural language explanation of the rule or policy, wherein the features include: (i) one or more conditions, (ii) one or more actions, and (iii) connections between the one or more events, conditions, and actions;
predicting a control structure comprised of one or more conditional statements based on the extracted features and model parameters learned from historical rules or policies; and
generating the rule or policy based on the control structure, wherein the rule or policy comprises the one or more conditional statements for executing the one or more actions based on evaluation of the one or more conditions.

2. The extended reality system of claim 1, wherein the extracting the features comprises:
segmenting the natural language explanation into sentences or utterances;
tokenizing the sentences or utterances to generate a list of words for each sentence or utterance;
labeling parts of speech within the sentences and utterances based on the list of words for each sentence or utterance;
detecting named entities within the sentences and utterances based on the labeled parts of speech and the list of words for each sentence or utterance;
extracting, using pattern matching, various elements of the sentences or utterances based on the named entities, the labeled parts of speech, and the list of words for each sentence or utterance, wherein the various elements comprise the one or more events, conditions, and actions;
extracting, using pattern matching, relationships between the various elements, wherein the relationships comprise the connections between the one or more events, conditions, and actions; and
converting: (i) the one or more events, conditions, and actions and (ii) the connections between the one or more events, conditions, and actions, into a predefined output template that maintains the relationships between the one or more events, conditions, and actions based on the connections between the one or more events, conditions, and actions.

3. The extended reality system of claim 1, wherein the operations further comprise:
prior to the capturing, determining a current state of the user, a complexity level of the rule or policy, a similarity score between the rule or policy and the historical rules or policies, or a combination thereof;
determining a mode for the rule or policy based on the current state, the complexity level, the similarity score, or a combination thereof, wherein the mode defines a level of detail required for learning the rule or policy; and
notifying the user of the level of detail required for learning the rule or policy based on the determined mode, wherein a first mode requires a natural language explanation and a second mode requires a natural language explanation and a demonstration.

4. The extended reality system of claim 1 or 3, wherein the operations further comprise:
capturing, using the one or more cameras, the demonstration of the rule or policy from the user, wherein the demonstration includes a series of images or frames visualizing context for the natural language explanation;
extracting contextual features from the demonstration of the rule or policy, wherein the contextual features include: (i) context associated with the one or more events, conditions, and actions, and (ii) context associated with the connections between the one or more events, conditions, and actions,
wherein the control structure is predicted based on the extracted features, the extracted contextual features, and the model parameters learned from the historical rule or policy information.

5. The extended reality system of claim 1, wherein the operations further comprise:
determining a confidence score for predicting the control structure;
comparing the confidence score to a mode threshold;
in response to the confidence score being below the mode threshold based on the comparing, determining additional information is required for the rule or policy and notifying the user that the additional information is required; and
in response to the confidence score being at or above the mode threshold based on the comparing, determining the control structure is acceptable.

6. The extended reality system of claim 5, wherein the operations further comprise capturing, using the one or more audio sensors, the one or more cameras, or a combination thereof, the additional information from the user, wherein the features are extracted from the natural language explanation of the rule or policy and the additional information.

7. The extended reality system of claim 1, wherein the operations further comprise executing the rule or policy based on the control structure, wherein executing comprises evaluating the one or more conditions, and executing the one or more actions based on the evaluation of the one or more conditions.

8. A computer implemented method comprising:
capturing, using one or more audio sensors, a natural language explanation of a rule or policy from a user;
extracting features from the natural language explanation of the rule or policy, wherein the features include: (i) one or more conditions, (ii) one or more actions, and (iii) connections between the one or more events, conditions, and actions;
predicting a control structure comprised of one or more conditional statements based on the extracted features and model parameters learned from historical rules or policies; and
generating the rule or policy based on the control structure, wherein the rule or policy comprises the one or more conditional statements for executing the one or more actions based on evaluation of the one or more conditions.

9. The computer implemented method of claim 8, wherein the extracting the features comprises:
segmenting the natural language explanation into sentences or utterances;
tokenizing the sentences or utterances to generate a list of words for each sentence or utterance;
labeling parts of speech within the sentences and utterances based on the list of words for each sentence or utterance;
detecting named entities within the sentences and utterances based on the labeled parts of speech and the list of words for each sentence or utterance;
extracting, using pattern matching, various elements of the sentences or utterances based on the named entities, the labeled parts of speech, and the list of words for each sentence or utterance, wherein the various elements comprise the one or more events, conditions, and actions;
extracting, using pattern matching, relationships between the various elements, wherein the relationships comprise the connections between the one or more events, conditions, and actions; and
converting: (i) the one or more events, conditions, and actions and (ii) the connections between the one or more events, conditions, and actions, into a predefined output template that maintains the relationships between the one or more events, conditions, and actions based on the connections between the one or more events, conditions, and actions.

10. The computer implemented method of claim 8, further comprising:
prior to the capturing, determining a current state of the user, a complexity level of the rule or policy, a similarity score between the rule or policy and the historical rules or policies, or a combination thereof;
determining a mode for the rule or policy based on the current state, the complexity level, the similarity score, or a combination thereof, wherein the mode defines a level of detail required for learning the rule or policy; and
notifying the user of the level of detail required for learning the rule or policy based on the determined mode, wherein a first mode requires a natural language explanation and a second mode requires a natural language explanation and a demonstration.

11. The computer implemented method of claim 8, further comprising:
capturing, using the one or more cameras, the demonstration of the rule or policy from the user, wherein the demonstration includes a series of images or frames visualizing context for the natural language explanation;
extracting contextual features from the demonstration of the rule or policy, wherein the contextual features include: (i) context associated with the one or more events, conditions, and actions, and (ii) context associated with the connections between the one or more events, conditions, and actions,
wherein the control structure is predicted based on the extracted features, the extracted contextual features, and the model parameters learned from the historical rule or policy information.

12. The computer implemented method of claim 8, further comprising:
determining a confidence score for predicting the control structure;
comparing the confidence score to a mode threshold;
in response to the confidence score being below the mode threshold based on the comparing, determining additional information is required for the rule or policy and notifying the user that the additional information is required; and
in response to the confidence score being at or above the mode threshold based on the comparing, determining the control structure is acceptable.

13. The computer implemented method of claim 12, wherein the processing further comprises capturing, using the one or more audio sensors, the one or more cameras, or a combination thereof, the additional information from the user, wherein the features are extracted from the natural language explanation of the rule or policy and the additional information.

14. The extended reality system of claim 8, further comprising executing the rule or policy based on the control structure, wherein executing comprises evaluating the one or more conditions, and executing the one or more actions based on the evaluation of the one or more conditions.

15. One or more non-transitory computer-readable media storing computer-readable instructions that, when executed by at least one processing system, cause a system to perform operations comprising:
capturing, using one or more audio sensors, a natural language explanation of a rule or policy from a user;
extracting features from the natural language explanation of the rule or policy, wherein the features include: (i) one or more conditions, (ii) one or more actions, and (iii) connections between the one or more events, conditions, and actions;
predicting a control structure comprised of one or more conditional statements based on the extracted features and model parameters learned from historical rules or policies; and
generating the rule or policy based on the control structure, wherein the rule or policy comprises the one or more conditional statements for executing the one or more actions based on evaluation of the one or more conditions.

16. The one or more non-transitory computer-readable media of claim 15, wherein the operations further comprise:
segmenting the natural language explanation into sentences or utterances;
tokenizing the sentences or utterances to generate a list of words for each sentence or utterance;
labeling parts of speech within the sentences and utterances based on the list of words for each sentence or utterance;
detecting named entities within the sentences and utterances based on the labeled parts of speech and the list of words for each sentence or utterance;
extracting, using pattern matching, various elements of the sentences or utterances based on the named entities, the labeled parts of speech, and the list of words for each sentence or utterance, wherein the various elements comprise the one or more events, conditions, and actions;
extracting, using pattern matching, relationships between the various elements, wherein the relationships comprise the connections between the one or more events, conditions, and actions; and
converting: (i) the one or more events, conditions, and actions and (ii) the connections between the one or more events, conditions, and actions, into a predefined output template that maintains the relationships between the one or more events, conditions, and actions based on the connections between the one or more events, conditions, and actions.

17. The one or more non-transitory computer-readable media of claim 15, wherein the operations further comprise:
prior to the capturing, determining a current state of the user, a complexity level of the rule or policy, a similarity score between the rule or policy and the historical rules or policies, or a combination thereof;
determining a mode for the rule or policy based on the current state, the complexity level, the similarity score, or a combination thereof, wherein the mode defines a level of detail required for learning the rule or policy; and
notifying the user of the level of detail required for learning the rule or policy based on the determined mode, wherein a first mode requires a natural language explanation and a second mode requires a natural language explanation and a demonstration.

18. The one or more non-transitory computer-readable media of claim 15, wherein the operations further comprise:
capturing, using the one or more cameras, the demonstration of the rule or policy from the user, wherein the demonstration includes a series of images or frames visualizing context for the natural language explanation;
extracting contextual features from the demonstration of the rule or policy, wherein the contextual features include: (i) context associated with the one or more events, conditions, and actions, and (ii) context associated with the connections between the one or more events, conditions, and actions,
wherein the control structure is predicted based on the extracted features, the extracted contextual features, and the model parameters learned from the historical rule or policy information.

19. The one or more non-transitory computer-readable media of claim 15, wherein the operations further comprise:
determining a confidence score for predicting the control structure;
comparing the confidence score to a mode threshold;
in response to the confidence score being below the mode threshold based on the comparing, determining additional information is required for the rule or policy and notifying the user that the additional information is required; and
in response to the confidence score being at or above the mode threshold based on the comparing, determining the control structure is acceptable.

20. The one or more non-transitory computer-readable media of claim 19, wherein the operations further comprise capturing, using the one or more audio sensors, the one or more cameras, or a combination thereof, the additional information from the user, wherein the features are extracted from the natural language explanation of the rule or policy and the additional information.
